(19) United States
(12) Patent Application Publication
(10) Pub. No.: US 2010/0061216 A1
(43) Pub. Date: Mar. 11, 2010

(54) OPTICAL HEAD UNIT AND OPTCAL INFORMATION RECORDING/REPRODUCING APPARATUS

(76) Inventor: Ryuichi Katayama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/449,551

(22) PCT Filed: Feb. 20, 2008
(86) PCT No.: PCT/JP2008/052800

§ 371 Date: Aug. 13, 2009

(30) Foreign Application Priority Data
Feb. 28, 2007 (JP) 2007-048608

(51) Int. Cl. G11B 7/135

(52) U.S. Cl. 369/112.02; 369/112.24; 369/112.03; G9B/7.112; G9B/7.113

(57) ABSTRACT

An optical head unit includes, apart from an objective lens toward a light source, an optical device that changes the image height of light incident onto the objective lens, wherein the optical device includes a concave lens and a convex lens. The objective lens is designed so that a coma aberration having a specific polarity occurs if the optical axis of the incident light tilts toward a specific direction. If the disk tilts, the convex lens is moved within the plane perpendicular to the optical axis, to change the image height of the light incident onto the objective lens, to thereby tilt the optical axis of light exiting from the convex lens with respect to the optical axis of light incident onto the concave lens. The objective lens generates a coma aberration having a polarity opposite to the polarity of the coma aberration attributable to the tilt of disk, to thereby cancel the coma aberration attributable to the tilt.

### TECHNICAL FIELD

The present invention relates to an optical head unit and an optical information recording/reproducing apparatus and, more particularly, to an optical head unit having the function of correcting a coma aberration and an optical information recording/reproducing apparatus including such an optical head unit.

### BACKGROUND ART

The recording density in an optical information recording/reproducing apparatus is inversely proportional to the square of diameter of the focused spot formed by an optical head unit on an optical recording medium. More specifically, a smaller diameter of the focused spot provides a higher recording density. The diameter of the focused spot is proportional to the wavelength of the light source in the optical head unit, and inversely proportional to the numerical aperture of an objective lens. Therefore, a shorter wavelength of the light source as well as a higher numerical aperture of the objective lens reduces the diameter the focused spot. For the CD (compact disk) standard of 650-MB capacity, the wavelength of the light source is 780 nm, and the numerical aperture of the objective lens is 0.45, whereas for the DVD (digital versatile disk) standard of 4.7-GB capacity, the wavelength of the light source is 650 nm, and the numerical aperture of the objective lens is 0.6.

As the standards having a recording density higher than the above DVD standard, there are a HD DVD (high-density digital-versatile disk) standard of 15-GB capacity and a BD (blu-ray disc) standard of 25-GB capacity. In these standards, the wavelength of the light source used for recording/reproducing is further reduced to raise the numerical aperture of the objective lens, thereby improving the recording density. More concretely, the wavelength of the light source is 405 nm for those standards, and the numerical aperture of the objective lens is 0.65 and 0.85 for the HD DVD standard and BD standard, respectively.

In general, a protective layer (overcoat layer) that covers an information recording layer is formed on the optical recording medium, whereby the light emitted from the optical head is incident onto the information recording layer via the protective layer, and the reflected light from the information recording layer is returned to the optical head side via the protective layer. The thickness of protective layer of the optical recording medium is 1.2 mm for the CD standard, 0.6 mm for the DVD standard, 0.6 mm for the HD DVD standard, and 0.1 mm for the BD standard. In this case, if the optical recording medium tilts with respect to the objective lens, the shape of focused spot is disturbed due to the coma aberration attributable to the tilt of the optical recording medium, thereby degrading the recording/reproducing characteristic. The coma aberration is inversely proportional to the wavelength and proportional to the third power of numerical aperture of the objective lens. Thus, a shorter wavelength of the light source as well as a higher numerical aperture of the objective lens narrows the margin of tilt of the optical recording medium with respect to the recording/reproducing characteristic. Therefore, in an optical head unit and optical information recording/reproducing apparatus having a shorter wavelength of the light source and a higher numerical aperture of the objective lens for achieving a higher recording density, it is needed to correct the coma aberration attributable to the tilt of the optical recording medium, in order for suppressing degradation of the recording/reproducing characteristic.

As the optical head unit having the function of correcting the coma aberration attributable to the tilt of the optical recording medium, there is an optical head unit that tilts the objective lens by using an actuator to correct the coma aberration. JP-2003-22886A, for example, describes that the coma aberration can be corrected by tilting the objective lens by using the actuator. FIG. 14 shows the configuration of this type of optical head unit. The light emitted from a semiconductor laser 233, which is a light source, is converted by a collimating lens 234 from a divergent light into a parallel light, divided by a diffractive optical element 235 into three lights including a zero-order light that is the main beam and ±first-order lights that are the subordinate lights. These lights are incident onto a polarizing beam splitter 236 as P-polarized lights, pass through the same in an amount of about 100%, are converted by a ¼-wavelength plate 237 from the linearly-polarized lights into circularly-polarized lights, converted by an objective lens 238 from the parallel lights into convergent lights, and are focused in a disk 239 that is the optical recording medium. The three reflected lights from the disk 239 are converted by the objective lens 238 from the divergent lights into parallel lights, converted by the ¼-wavelength plate 237 from the circularly-polarized lights into linearly-polarized lights having a polarization direction perpendicular to that in the forward path, incident onto the polarizing beam splitter 236 as S-polarized lights and reflected therefrom in an amount of about 100%, and received by a photodetector 242 via a cylindrical lens 240 and a concave lens 241.

FIGS. 15A to 15C show the principle of correcting the coma aberration. It is assumed here that the tilt of disk 239 occurs around the axis perpendicular to the sheet of drawing, and it is defined that the signs of tilt in the clockwise direction and counterclockwise direction are negative and positive, respectively. FIG. 15A shows the case where the tilt of disk 239 is zero. In this state, the optical axis of the light incident onto the objective lens 238 coincides with the optical axis of the objective lens 238, whereby the direction of normal line of the disk 239 coincides with the optical axis direction of the objective lens 238. Thus, a coma aberration is not generated.

FIG. 15B shows the case where the tilt of disk 239 is negative. When the disk 239 tilts clockwise, the direction of normal line of the disk 239 tilts clockwise with respect to the optical axis direction of the objective lens 238, whereby a coma aberration is generated. Thus, the objective lens 238 is tilted clockwise by the same angle as that of the disk 239 by using an actuator not illustrated. In this way, the direction of normal line of the disk 239 and the optical axis direction of the objective lens 238 coincide with each other, whereby a coma aberration is corrected. FIG. 15C shows the case where the tilt of disk 239 is positive. When the disk 239 tilts counterclockwise, the direction of normal line of the disk 239 tilts counterclockwise with respect to the optical axis direction of the objective lens 238, whereby the coma aberration is generated. In this case, the objective lens 238 is tilted counterclockwise by the actuator not illustrated by the same angle as that of the disk 239 so that the direction of normal line of the disk 239 and the optical axis direction of the objective lens 238 coincide with each other, whereby the coma aberration is corrected.

In consideration that a plurality of beams are incident onto the objective lens, the point at which the plurality of beams exiting from the objective lens cross each other is referred to as image point, and the distance from the optical axis of the objective lens to the image point is referred to as image height. In addition, if the image height of the light incident onto the objective lens is not zero, the condition under which the coma aberration is not generated is referred to as sine condition. After the coma aberration is corrected in the case of FIGS. 15B and 15C, the optical axis of the light incident onto the objective lens 238 and the optical axis of the objective lens 238 do not coincide with each other, whereby the image height of the light incident onto the objective lens is not zero. However, since the objective lens 238 is designed to satisfy the sine condition, another coma aberration is not generated due to the correction.

There is an optical head unit that corrects the coma aberration by using a liquid-crystal optical element, as another example of the optical head unit having the function of correcting the coma aberration attributable to the tilt of the optical recording medium. The fact that the coma aberration can be corrected using the liquid-crystal optical element is described in JP-1999-110802A, for example. FIG. 16 shows the configuration of this type of the optical head unit. The light emitted from a semiconductor laser 233, which is a light source, is converted by a collimating lens 234 from a divergent light into a parallel light, and is divided by a diffractive optical element 235 into three lights including a zero-order light that is the main beam and ±first-order diffracted lights that are subordinate beams. These lights are incident onto a polarizing beam splitter 236 as P-polarized lights, pass through the same in an amount of about 100%, pass through the liquid-crystal optical element 243, are converted by a ¼-wavelength plate 237 from linearly-polarized lights into circularly-polarized lights, are converted by an objective lens 238 from parallel lights into convergent lights, and are focused in a disk 239 that is the optical recording medium. Three reflected lights from the disk 239 are converted by the objective lens 238 from divergent lights into parallel lights, are converted by the ¼-wavelength plate 237 from circularly-polarized lights into linearly-polarized lights having a polarization direction perpendicular to that in the forward path, pass through the liquid-crystal optical element 243 in the backward direction, are incident onto the polarizing beam splitter 236 as S-polarized lights, are reflected therefrom in an amount of about 100%, and are received by a photodetector 242 via a cylindrical lens 240 and a convex lens 241.

FIG. 17 shows the liquid-crystal optical element 243 in a top plan view. The liquid-crystal optical element 243 has a configuration wherein a liquid-crystal polymer is sandwiched between two substrates, and electrodes for applying an AC voltage to the liquid-crystal polymer are formed on the surface of the substrates near the liquid-crystal polymer. An electrode formed on one of the substrates is a patterned electrode that is divided into five areas 244a-244e, and another electrode formed on the other of the substrates is a full-area electrode. It is defined here that V1 represents RMS value of the AC voltage applied between the area 244b, 244e of the patterned electrode and the full-area electrode, V2 represents RMS value of the AC voltage applied between the area 244a of the patterned electrode and the full-area electrode, and V3 represents RMS value of the AC voltage applied between the area 244c, 244d of the patterned electrode and the full-area electrode. In this case, if a voltage V, where the V is defined as V=V1−V2=V2−V3, is changed, the coma aberration generated in the liquid-crystal optical element 243 is changed.

If the tilt of disk 239 is zero (corresponding to FIG. 15A), the voltage V is controlled to a zero volt. In this case, the coma aberration is not generated in the liquid-crystal optical element 243. If the tilt of disk 239 is negative (corresponding to FIG. 15B), the voltage V is set at a suitable negative value. In this case, the liquid-crystal optical element 243 generates another coma aberration that cancels the coma aberration attributable to the tilt of disk 239, to thereby correct the coma aberration. If the tilt of disk 239 is positive (corresponding to FIG. 15C), the voltage V is set at a suitable positive value. In this case, the liquid-crystal optical element 243 generates another coma aberration that cancels the coma aberration attributable to the tilt of disk 239, to thereby correct the coma aberration.

There is an optical head unit described in JP-2006-252725A, as another example of the optical head unit having the function of correcting the coma aberration attributable to the tilt of the optical recording medium. In this patent publication, the coma aberration is corrected by a configuration wherein two objective lenses belonging two groups are provided therein and a liquid lens is moved within a plane perpendicular to the optical axis.

In the optical head unit illustrated in FIG. 14, the objective lens 238 is tilted by an actuator to thereby correct the coma aberration attributable to the tilt of disk 239. However, upon tilting the objective lens 238 by using the actuator, a current passes through a coil provided around the periphery of the objective lens 238 to generate a heat in the coil, whereby a nonaxisymmetric heat distribution occurs in the objective lens. Since a low-cost plastic material is generally used as the material for the objective lens 238, and the refractive index of the plastic material changes depending on the temperature thereof, the nonaxisymmetric temperature distribution, if occurs in the objective lens 238, generates an astigmatism in the objective lens 238 as a result thereof. Thus, the focused spot has a disturbed shape to degrade the recording/reproducing characteristic. The tilt of objective lens 238, if occurs, reduces the distance between the objective lens 238 and the disk 239, thereby incurring another problem of an increase in the risk that the objective lens 238 collides with the disk 239.

In the optical head unit shown in FIG. 16, use of the liquid-crystal optical element 243 can correct the coma aberration attributable to the tilt of disk 239. However, the phase distribution generated, with respect to the forward-path light advancing from the semiconductor laser 233 to the disk 239, by the coma aberration attributable to the tilt of disk 239 is a curved-surface phase distribution, whereas the phase distribution generated in the liquid-crystal optical element 243 is a stepwise phase distribution. Thus, the latter cannot completely cancel the former whereby a higher-order aberration remains therein. In addition, if the objective lens 238 is moved within the plane perpendicular to the optical axis for performing a tracking server operation, the center of the phase distribution generated by the coma aberration attributable to the tilt of disk 239 deviates from the center of the phase distribution generated in the liquid-crystal optical element 243, whereby an astigmatism occurs with respect to the forward-path light. As a result, the focused spot has a disturbed shape to degrade the recording/reproducing characteristic.

In the optical head unit described in Patent Publication 3, two objective lens belonging to two groups are used therein. Thus, it is difficult to reduce the size and weight of the objective lens. As a result, it is difficult to increase the operating band of the actuator that drives the objective lens, and thus to improve the operating speed thereof.

### SUMMARY OF THE INVENTION

It is an object of the present invention to provide an optical head unit and an optical information recording/reproducing apparatus that do not degrade, upon correcting the coma aberration attributable to the tilt of an optical recording medium, the recording/reproducing characteristic due to another aberration, have a lower risk that the objective lens collides with the optical recording medium, and are capable of handling a higher operating speed.

The present invention provides an optical head unit including: a light source; an objective lens that focuses light exiting from the light source to form a focused spot in an optical recording medium; and a photodetector that receives reflected light from the optical recording medium, wherein: an image height of the light incident onto the objective lens and a coma aberration generated in the objective lens have a specific relationship therebetween; the optical head unit comprises, between the light source and the objective lens, an optical device that changes the image height of the light incident onto the objective lens, in order to change the coma aberration generated in the objective lens.

The present invention provides an optical information recording/reproducing apparatus including: the above optical head unit according to the present invention; and a circuit system that drives the optical device so as to correct the coma aberration with respect to light exiting from the objective lens.

The above and other objects, features and advantages of the present invention will be more apparent from the following description, referring to the accompanying drawings.

### BRIEF DESCRIPTION OF THE DRAWINGS

FIG. 1 is a block diagram showing an optical head unit according to a first embodiment of the present invention.

FIGS. 2A to 2C are sectional views showing operation of correcting the coma aberration in the optical head unit shown in FIG. 1.

FIGS. 3A to 3C are sectional views showing operation of correcting the spherical aberration in the optical head unit shown in FIG. 1.

FIG. 4 is a block diagram showing an optical head unit according to a second embodiment of the present invention.

FIGS. 5A to 5C are sectional views showing operation of correcting the coma-aberration in the liquid-crystal optical element shown in FIG. 4.

FIGS. 6A to 6C are sectional views showing operation of correcting the spherical aberration in the liquid-crystal optical element shown in FIG. 4.

FIGS. 7A and 7B are top plan views showing the liquid-crystal optical element.

FIG. 8 is a block diagram showing an optical head unit according to a third embodiment of the present invention.

FIGS. 9A to 9C are sectional views showing operation of correcting the coma aberration in the liquid optical element shown in FIG. 8.

FIGS. 10A to 10C are sectional views showing operation of correcting the spherical aberration in the liquid optical element shown in FIG. 8.

FIG. 11 is a top plan view showing the liquid optical element.

FIGS. 12A to 12C are top plan views showing the diffractive optical element.

FIG. 13 is a block diagram showing an optical information recording/reproducing apparatus including the optical head unit.

FIG. 14 is a block diagram showing a conventional optical head unit having the function of correcting the coma aberration.

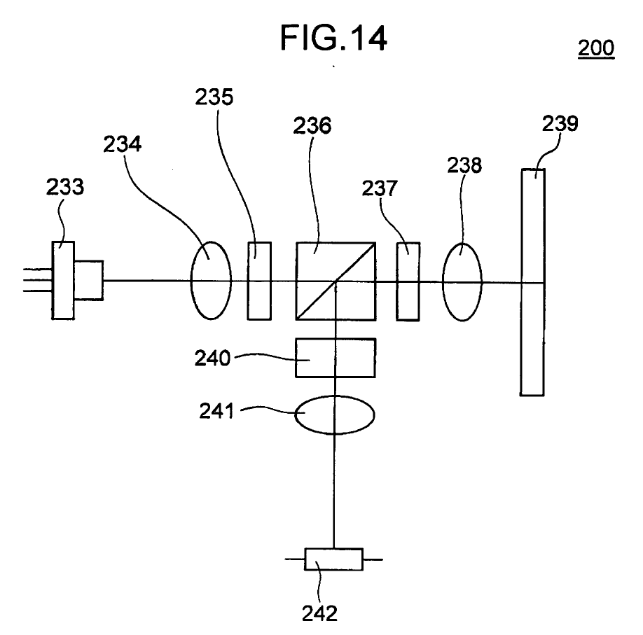

FIGS. 15A to 15C are sectional views showing the principle of correcting the coma aberration in the optical head unit shown in FIG. 14.

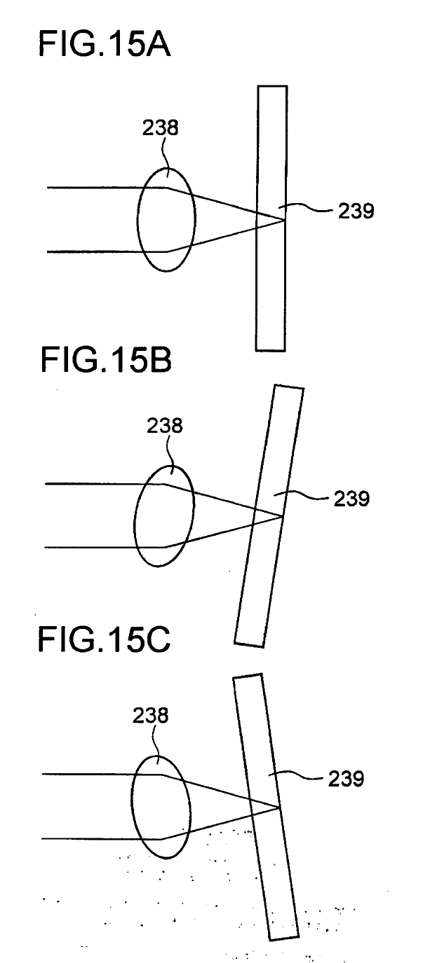

FIG. 16 is a block diagram showing another example of the conventional optical head unit having the function of correcting the coma aberration.

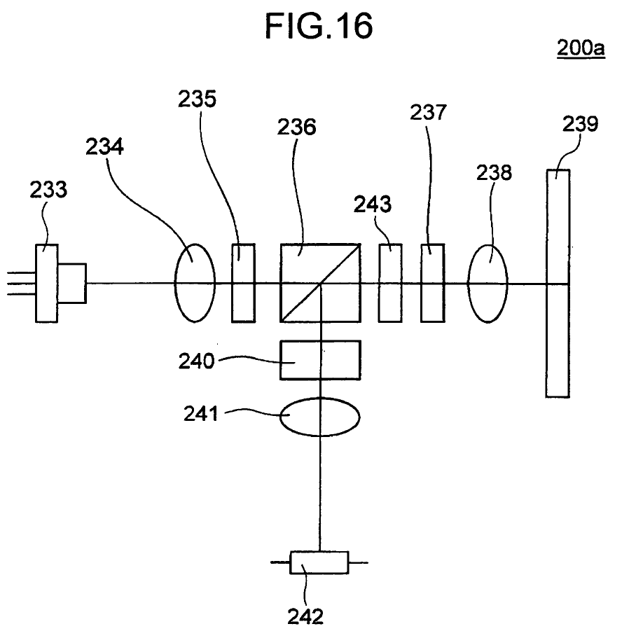

FIG. 17 is a top plan view showing the liquid-crystal optical element in the optical head unit shown in FIG. 16.

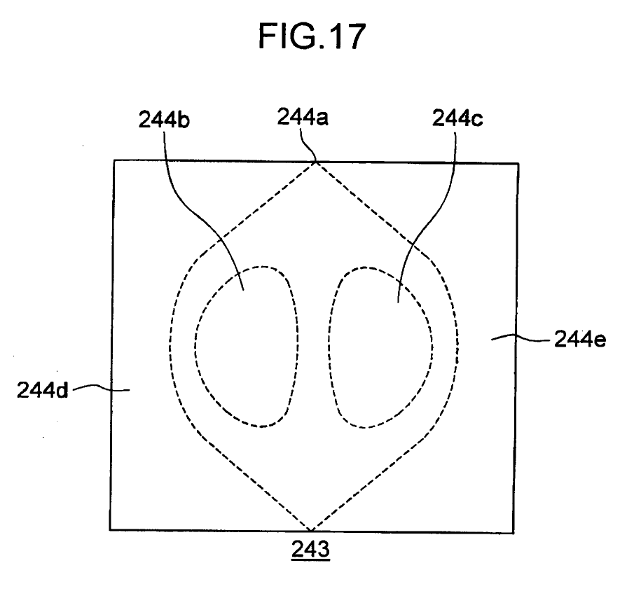

### DETAILED DESCRIPTION OF THE INVENTION

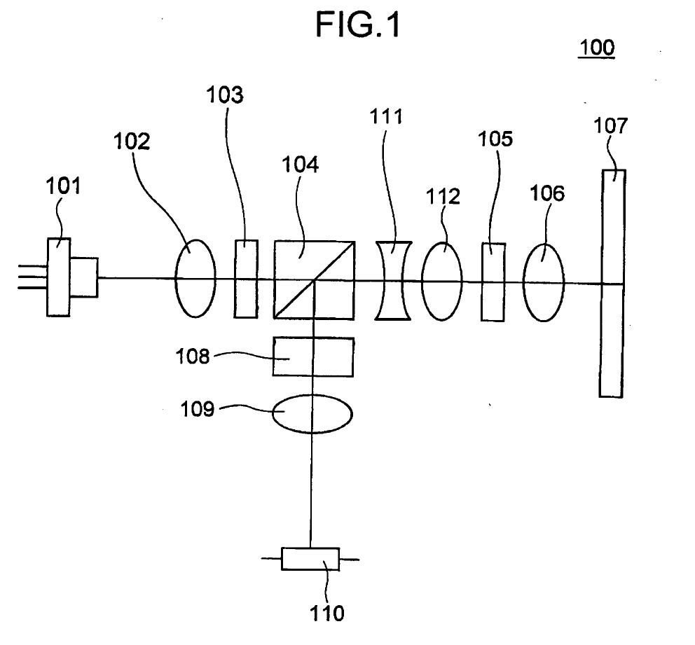

Hereinafter, exemplary embodiments of the present invention will be described in detail with reference to the drawings. FIG. 1 shows the configuration of an optical head unit according to a first embodiment of the present invention. The optical head unit 100 includes a semiconductor laser 101, a collimating lens 102, a diffractive optical element 103, a polarizing beam splitter 104, a ¼-wavelength plate 105, an objective lens 106, a cylindrical lens 108, a convex lens 109, a photodetector 110, a concave lens 111, and a convex lens 112. The optical head unit 100 is mounted on an optical information recording/reproducing apparatus that performs recording/reproducing on a disk 107 that configures an optical recording medium.

The light emitted from the semiconductor laser 101 that is a light source is converted by the collimating lens 102 from a divergent light into a parallel light, and is divided by the diffractive optical element 103 into three lights including a zero-order light that is the main beam, and ±first-order lights that are subordinate beams. These lights are incident onto the polarizing beam splitter 104 as P-polarized lights, pass through the same in an amount of about 100%, pass through the concave lens 111 and convex lens 112, and are converted by the ¼-wavelength plates 105 from linearly-polarized lights into circularly-polarized lights. Thereafter, the lights are converted by the objective lens 106 from parallel lights into convergent lights, and are focused within the disk 107.

The three reflected lights from the disk 107 are converted by the objective lens 106 from divergent lights into parallel lights, are converted by the ¼-wavelength plate 105 from circularly-polarized lights into linearly-polarized lights having a polarization direction perpendicular to that in the forward path, passes through the convex lens 112 and concave lens 111 in the backward direction, are incident onto the polarizing beam splitter 104 as S-polarized lights, and are reflected therefrom in an amount of about 100%. The lights reflected by the polarizing beam splitter 104 are received by the photodetector 110 via the cylindrical lens 108 and convex lens 109. Here, the objective lens 106 does not satisfy the sine condition. The concave lens 111 and convex lens 112 are configured so that the positional relationship therebetween can be changed by an actuator not illustrated, to form an optical device that changes the image height of the light incident onto the objective lens 106.

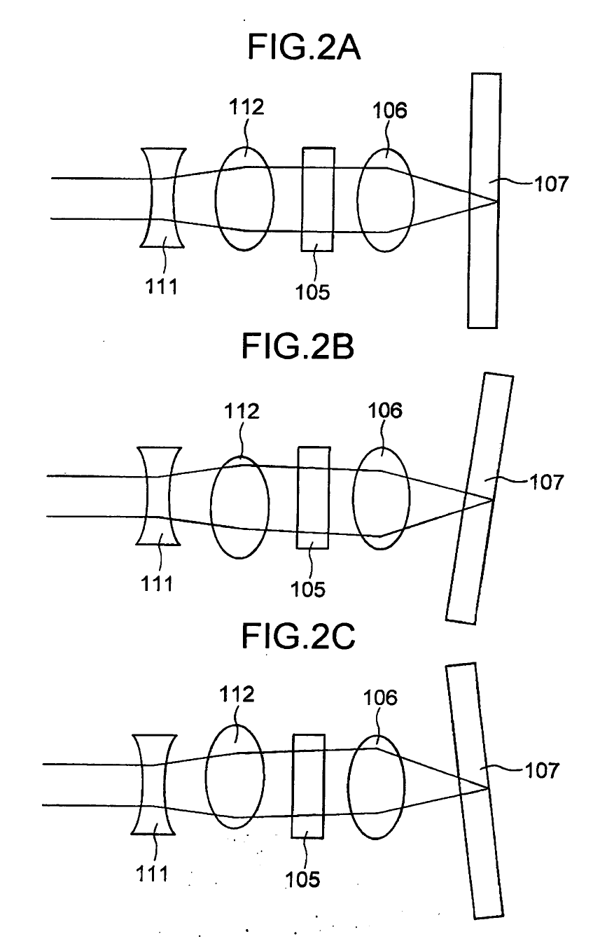

FIGS. 2A to 2C show the principle of correcting the coma aberration. It is assumed here that the tilt of disk 107 is generated around an axis perpendicular to the sheet of drawing, and it is defined that the sign of a clockwise rotation is negative whereas the sign of a counterclockwise rotation is positive. The forward-path light traveling from the semiconductor laser 101 to the disk 107 is converted by the concave lens 111 from a parallel light into a divergent light, and returned by the convex lens 112 from the divergent light to the parallel light. The objective lens 106 is designed so that, if the optical axis of the incident light tilts clockwise with respect to the optical axis of the objective lens 106, another coma aberration having a polarity opposite to the polarity of the coma aberration attributable to a negative tilt of the disk 107 occurs in the objective lens 106. It is also designed so that, if the optical axis of the incident light tilts counterclockwise with respect to the optical axis of the objective lens 106, another coma aberration having a polarity opposite to the polarity of the coma aberration attributable to a positive tilt of the disk 107 occurs in the objective lens 106.

FIG. 2A shows the case where the tilt of disk 107 is zero. When the tilt of disk 107 is zero, the positional relationship between the concave lens 111 and the convex lens 112 is controlled so that both the optical axes thereof coincide with each other. The coincidence of the optical axis of the concave lens 111 and optical axis of the convex lens 112 allows the optical axis of the light incident onto the concave lens 111 to coincide with the optical axis of the light exiting from the convex lens 112. In addition, the optical axis of the light incident onto the objective lens 106 and the optical axis of the objective lens 106 coincide with each other, and the direction of normal line of the disk 107 coincide with the optical axis direction of the objective lens 106. Since the image height of the light incident onto the objective lens 106 is zero at this stage, the coma aberration is not generated.

FIG. 2B shows the case where the tilt of disk 107 is negative. When the disk 107 tilts clockwise, the direction of normal line of the disk 107 tilts clockwise with respect to the optical axis direction of the objective lens 106, whereby a coma aberration is generated. Thus, the convex lens 112 is moved by the actuator not illustrated within the plane perpendicular to the optical axis by a suitable distance in the downward direction as viewed in the figure. In this way, the optical axis of the convex lens 112 is deviated with respect to the optical axis of the concave lens 111 in the downward direction as viewed in the figure, whereby the optical axis of the light exiting from the convex lens 112 tilts clockwise with respect to the optical axis of the light incident onto the concave lens 111. As a result, the optical axis of the light incident onto the objective lens 106 tilts clockwise with respect to the optical axis of the objective lens 106, whereby the image height of the light incident onto the objective lens 106 is no longer zero. Thus, even if the direction of normal line of the disk 107 coincides with the optical axis direction of the objective lens 106, a coma aberration occurs in the objective lens 106. By setting the amount of movement of the convex lens 112 at a suitable value, another coma aberration that cancels the coma aberration attributable to the tilt of disk 107 can be generated to correct the coma aberration.

FIG. 2C shows the case where the tilt of disk 107 is positive. When the disk 107 tilts counterclockwise, the direction of normal line of the disk 107 tilts counterclockwise with respect to the optical axis direction of the objective lens 106, whereby a coma aberration is generated. Thus, the convex lens 112 is moved by the actuator not illustrated within the plane perpendicular to the optical axis by a suitable distance in the upward direction as viewed in the figure. In this way, the optical axis of the convex lens 112 is deviated in the upward direction with respect to the optical axis of the concave lens 111, whereby the optical axis of the light exiting from the convex lens 112 tilts counterclockwise with respect to the optical axis of the light incident onto the concave lens 111. As a result, the optical axis of the light incident onto the objective lens 106 tilts counterclockwise with respect to the optical axis of the objective lens 106, whereby the image height of the light incident onto the objective lens 106 is no longer zero. Thus, even if the direction of normal line of the disk 107 coincides with the optical axis direction of the objective lens 106, a coma aberration occurs in the objective lens 106. By setting the amount of movement of the convex lens 112 at a suitable value, the image height of the light incident onto the objective lens 106 assumes a suitable value, whereby another coma aberration that cancels the coma aberration attributable to the tilt of disk 107 occurs in the objective lens 106, to correct the coma aberration. Note that, as the actuator that moves the convex lens 112 within the plane perpendicular to the optical axis, an electromagnetic-driven actuator may be used which is similar to, for example, an actuator that moves the objective lens within the plane perpendicular to the optical axis for performing the tracking servo operation in a typical optical head unit.

An example will be described here using concrete values. It is assumed that the wavelength of the semiconductor laser 101, numerical aperture of the objective lens 106, and thickness of protective layer of the disk 107 are 405 nm, 0.85 and 0.1 mm, respectively. It is also assumed that the focal lengths of the objective lens, concave lens 111 and convex lens 112 are 1.76 mm, −10 mm and 12 mm, respectively. The objective lens 106 is designed so that, if the convex lenses 112 is moved by 10 μm within the plane perpendicular to the optical axis, the objective lens 106 generates a coma aberration of 0.01 λrms. An excessively smaller shift amount of the convex lens 112 that allows the objective lens 106 to generate a specific coma aberration requires a higher accuracy of the actuator that drives the drives convex lens 112. On the other hand, an excessively larger shift amount of the convex lens 112 that provides the specific amount of coma aberration requires a larger size of the actuator that drives the convex lens 112. Thus, it is preferable to design the objective lens 106 so that the shift amount of the convex lens 112 that allows the objective lens 106 to generate a coma aberration of 0.01λrms is set within a range around 5 to 20 μm.

In the present embodiment, the change of position of the concave lens 111 and convex lens 112 within the plane perpendicular to the optical axis changes the image height of the light incident onto the objective lens 106, thereby correcting the coma aberration attributable to the tilt of disk 107. In the present embodiment, since the objective lens 106 is not tilted by the actuator upon correction of the coma aberration, the nonaxisymmetric temperature distribution is not generated in the objective lens 106. Thus, even if a plastic material is used for the material of the objective lens 106, the astigmatism is not generated in the objective lens 106. Accordingly, the focused spot is free from the shape disturbance whereby the recording/reproducing characteristic is not degraded.

In the present embodiment, the distance between the objective lens 106 and the disk 107 is not reduced upon correction of the coma aberration, whereby the risk that the objective lens 106 collides with the disk 107 is reduced. In addition, since the coma aberration attributable to the tilt of disk 107 is corrected by generation of the coma aberration in the objective lens 106, the phase distribution generated by the coma aberration attributable to the tilt of disk 107 can be completely cancelled by the phase distribution generated in the objective lens 106 whereby a higher-order aberration does not remain with respect to the forward-path light. Even if the objective lens 106 moves within the plane perpendicular to the optical axis, the center of the phase distribution generated by the coma aberration attributable to the tilt of disk 107 does not deviate from the center of the phase distribution generated in the objective lens 106, whereby an astigmatism does not occur with respect to the forward-path light. Therefore, the shape of focused spot is not disturbed and the recording/reproducing characteristic is not degraded. Further, since a single-body objective can be used as the objective lens 106, the objective lens 106 may be reduced in size and weight thereof, whereby the actuator that drives the objective lens 106 may have a broader operating band and a higher operating speed without a problem.

The relationship between the tilt of optical axis of the light incident onto the objective lens 106 and the coma aberration generated in the objective lens 106 is not limited to the above relationship, and may be reversed therefrom. More specifically, the objective lens 106 may be designed so that, if the optical axis of the light incident onto the objective lens 106 tilts counterclockwise with respect to the optical axis of the objective lens 106, another coma aberration having a polarity opposite to the polarity of the coma aberration attributable to a negative tilt of the disk 107 is generated, and so that, if the optical axis of the light incident onto the objective lens 106 tilts clockwise with respect to the optical axis of the objective lens 106, another coma aberration having a polarity opposite to the polarity of the coma aberration attributable to a positive tilt of the disk 107 is generated. In this case, upon correction of the coma aberration, contrary to FIG. 2, the convex lens 112 is moved in the upward direction if the tilt of disk 107 is negative, whereas the convex lens 112 is moved in the downward direction if the tilt of disk 107 is positive.

In FIGS. 2A to 2C, the image height of the light incident onto the objective lens 106 is changed by moving the convex lens 112 within the plane perpendicular to the optical axis, with the concave lens 111 being fixed. In an alternative, the image height of the light incident onto the objective lens 106 may be changed by moving the concave lens 111 within the plane perpendicular to the optical axis, with the convex lens 112 being fixed. In such a case, tilting of the optical axis of the light incident onto the objective lens 106 clockwise with respect to the optical axis of the objective lens 106 may be achieved by moving the concave lens 111 in the upward direction as viewed in FIGS. 2A to 2C, whereas the tilting of the optical axis of the light incident onto the objective lens 106 counterclockwise with respect to the optical axis of the objective lens 106 may be achieved by moving the concave lens 111 in the downward direction as viewed in FIG. 2.

Note that in consideration of a plurality of beams configuring the light incident onto the objective lens, the point at which these beams cross one another is referred to as object point, and the position of the object point with respect to the objective lens is referred to as object-point position. The sign of the object-point position is negative if the object point is located on the light emitting side of the objective lens, and is positive if the object point is located on the light incident side thereof. In a typical optical information recording/reproducing apparatus, the objective lens is designed so that, if the object-point position of the light incident onto the objective lens is a specific value, the spherical aberration generated in the protective layer of the optical recording medium having a thickness defined by the standard is corrected with respect to the light exiting from the objective lens. In this case, if the thickness of protective layer of the optical recording medium deviates from the standard value, the spherical aberration attributable to the thickness deviation of the protective layer of the optical recording medium disturbs the shape of focused spot to degrade the recording/reproducing characteristic. This spherical aberration is inversely proportional to the wavelength of light source and is proportional to the fourth power of the numerical aperture of the objective lens. Therefore, a shorter wavelength of the light source and a higher numerical aperture of the objective lens narrow the margin of the thickness deviation of the protective layer in the optical recording medium with respect to the recording/reproducing characteristic. Thus, in an optical head unit and an optical information recording/reproducing apparatus that include a light source having a shorter wavelength and an objective lens having a higher numerical aperture for achieving a higher recording density, it is needed to correct the spherical aberration attributable to the thickness deviation of the protective layer in the optical recording medium.

In the optical head unit 100 of the present embodiment, the concave lens 111 and convex lens 112, which also act as the optical device that changes the object-point position of the light incident onto the objective lens 106, have the function of correcting the spherical aberration attributable to the thickness deviation of the disk protective layer. By realizing, in the concave lens 111 and convex lens 112, the function that corrects the coma aberration attributable to the tilt of disk and the function that corrects the spherical aberration attributable to the thickness deviation of the protective layer of disk 107, an optical head unit having these two functions can be realized with a simple configuration.

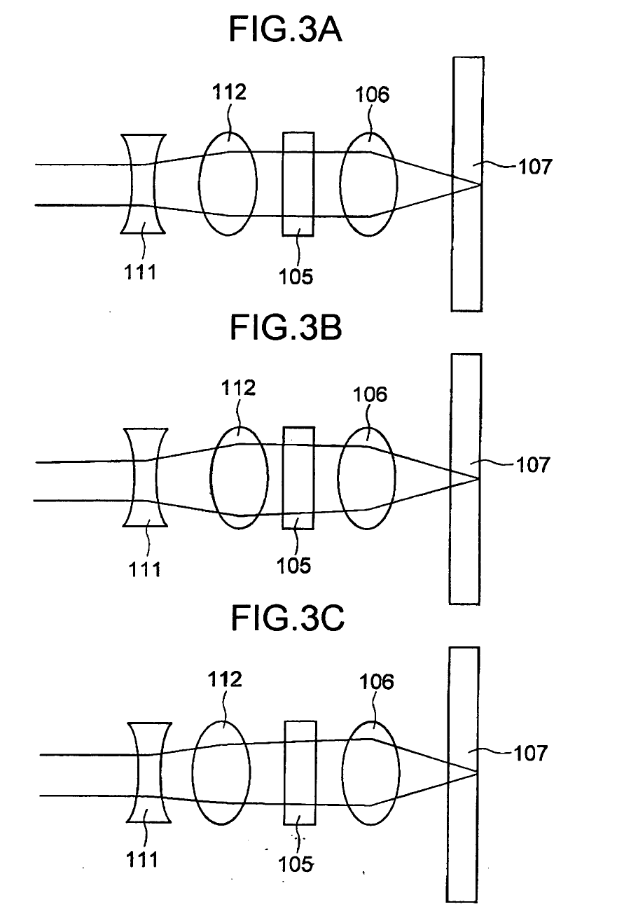

FIGS. 3A to 3C show the principle of correcting the spherical aberration. The objective lens 106 is designed so that, if the object-point position of the light incident onto the objective lens 106 is infinite, that is, if the light incident onto the objective lens 106 is a parallel light, the spherical aberration generated in the protective layer of disk 107 that has the thickness defined by the standard is corrected with respect to the light exiting from the objective lens 106. The spherical aberration attributable to the thickness deviation of protective layer of the disk can be corrected by changing the distance between the concave lens 111 and the convex lens 112 in accordance with the thickness deviation of the protective layer to thereby change the object-point position of the light incident onto the objective lens 106.

FIG. 3A shows the case where the thickness of protective layer of the disk 107 is equal to the standard value. In this case, the distance between the concave lens 111 and the convex lens 112 is such that the light incident onto the concave lens 111 as a parallel light exits from the convex lens 112 as a parallel light. In this state, the light incident onto the objective lens 106 is a parallel light, wherein the object-point position of the light incident onto the objective lens 106 is infinite and thus the spherical aberration is not generated.

FIG. 3B shows the case where the thickness of protective layer of the disk 107 is smaller than the standard value. The smaller thickness of protective layer of the disk 107 as compared to the standard value incurs a spherical aberration. Thus, the convex lens 112 is moved by a suitable distance in the rightward direction in the figure along the optical axis direction by the actuator not illustrated. The rightward movement of the convex lens 112 provides a larger distance between the concave lens 111 and the convex lens 112 as compared to the state shown in FIG. 3A, whereby the light incident onto the concave lens 111 as a parallel light exits as a convergent light from the convex lens 112. As a result, the light incident onto the objective lens 106 is a convergent light, and the object-point position of the light incident onto the objective lens 106 is a finite negative value, whereby an additional spherical aberration occurs in the objective lens 106. By setting the shift amount of the convex lens 112 at a suitable value, the object-point position of the light incident onto the objective lens 106 is set at a suitable value, whereby the additional spherical aberration that cancels the spherical aberration attributable to the thickness deviation of the protective layer of disk 107 occurs in the objective lens 106 to correct the spherical aberration.

FIG. 3C shows the case where the thickness of protective layer of the disk 107 is larger than the standard value. The lager thickness of protective layer of the disk 107 as compared to the standard value generates the spherical aberration. Thus, the convex lens 112 is moved by a suitable distance in the leftward direction in the figure along the optical axis by the actuator not illustrated. The leftward movement of the convex lens 112 provides a distance between the concave lens 111 and the convex lens 112 that is narrower as compared to the state shown in FIG. 3A, whereby the light incident onto the concave lens 111 as a parallel light exits as a divergent light from the convex lens 112. As a result, the object-point position of the light incident onto the objective lens 106 is a finite positive value, whereby an additional spherical aberration occurs in the objective lens 106. By setting the shift amount of the convex lens 112 at a suitable value, the object-point position of the light incident onto the objective lens 106 is set at a suitable value, whereby the additional spherical aberration that cancels the spherical aberration attributable to the thickness deviation of the protective layer of disk 107 occurs in the objective lens 106 to correct the spherical aberration. As the actuator that moves the convex lens 112 along the optical axis, an electromagnetic-driven actuator similar to an actuator that moves the objective lens along the optical axis for performing the focus servo operation, for example in a typical optical head unit can be used.

An example of the optical head unit will be described with reference to concrete values. It is assumed that the wavelength of the semiconductor laser 101, numerical aperture of the objective lens 106 and thickness of protective layer of the disk 107 are 405 nm, 0.85 and 0.1 mm, respectively. It is also assumed that the focal lengths of the objective lens 106, concave lens 111, and convex lenses 112 are 1.76 mm, −10 mm and 12 mm, respectively. In this case, the objective lens 106 is designed so that, if the convex lens 112 is moved along the optical axis by 20 μm, for example, a spherical aberration of 0.01 λrms is generated in the objective lens 106.

In FIGS. 3A to 3C, the object-point position of the light incident onto the objective lens 106 is changed by moving the convex lens 112 along the optical axis, with the position of the concave lens 111 being fixed. In an alternative, the concave lens 111 may be moved along the optical axis to change the object-point position of the light incident onto the objective lens 106, with the convex lens 112 being fixed. In this case, it is sufficient that, if the object-point position of the light incident onto the objective lens 106 is set at a finite positive value, the concave lens 111 be moved in the leftward direction as viewed in FIG. 3, whereas if the object-point position of the light incident onto the objective lens 106 is set at a finite negative value, the concave lens 111 be moved in the rightward direction as viewed in FIGS. 3A to 3C.

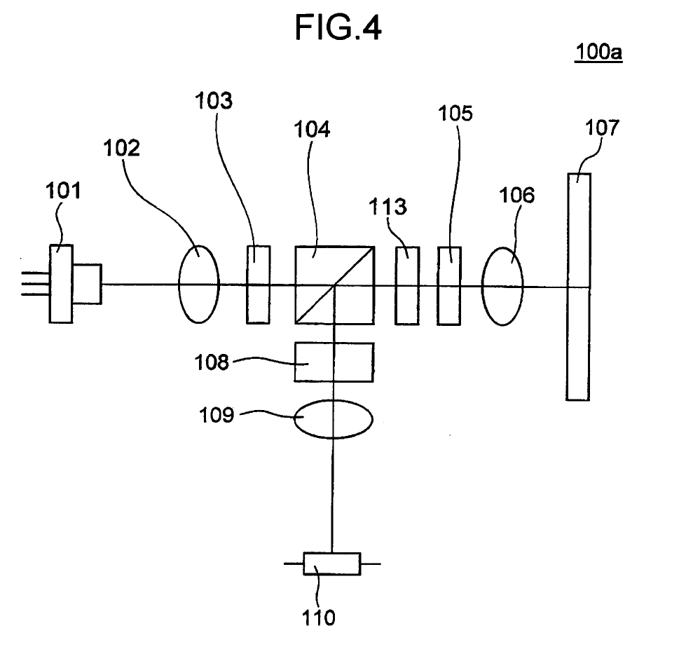

FIG. 4 shows the configuration of an optical head unit according to a second embodiment of the present invention. The optical head unit 100a of the present embodiment uses, instead of the concave lens 111 and convex lens 112 in FIG. 1, a liquid-crystal optical element 113 as the optical device that changes the image height of incident light, and is different from the optical head unit of the first embodiment in this point.

The light exiting from the semiconductor laser 101 that is a light source is converted by the collimating lens 102 from a divergent light into a parallel light, and is divided by the diffractive optical element 103 into three lights including a zero-order light that is the main beam, and ±first-order lights that are subordinate beams. These lights are incident onto the polarizing beam splitter 104 as P-polarized lights, pass through the same in an amount of 100%, pass through the liquid-crystal optical element 113, are converted by the ¼-wavelength plate 105 from linearly-polarized lights into circularly-polarized lights, are converted by the objective lens 106 from parallel lights into convergent lights, and are focused within a disk 107 that is the optical recording medium.

Three reflected lights from the disk are converted by the objective lens 106 from divergent lights into parallel lights, are converted by the ¼-wavelength plate 105 from circularly-polarized lights into linearly-polarized lights having a polarization direction perpendicular to that in the forward path, pass through the liquid-crystal optical element 113 in the backward direction, are incident onto the polarizing beam splitter 104 as S-polarized lights, are reflected therefrom in an amount of about 100%, and are received by the photodetector 110 via the cylindrical lens 108 and convex lens 109. Here, the objective lens 106 does not satisfy the sine condition.

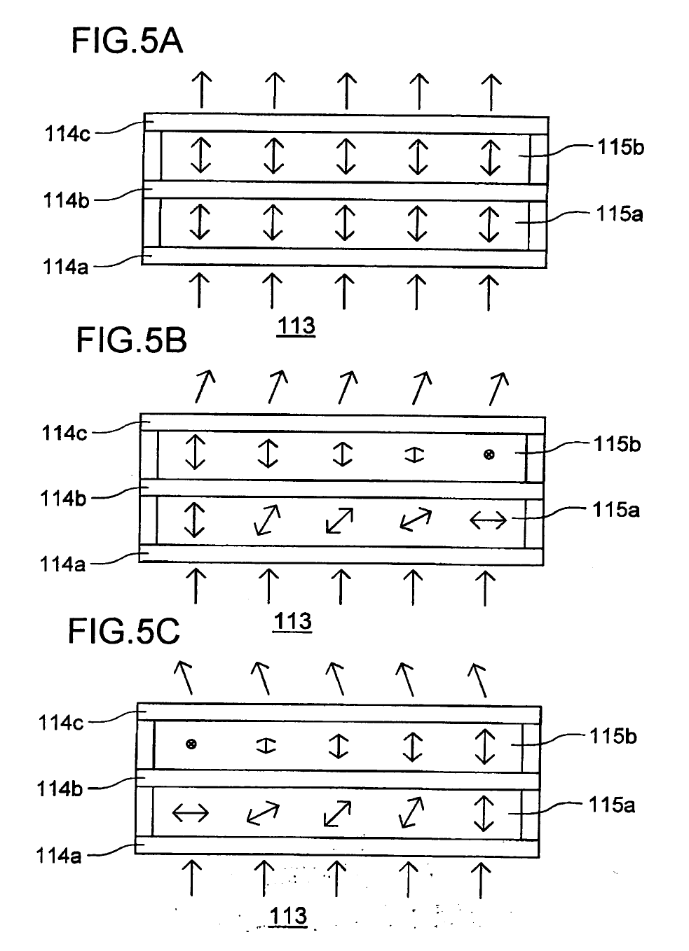

FIGS. 5A to 5C show a section of the liquid-crystal optical element 113. The liquid-crystal optical element 113 has a configuration wherein a liquid-crystal polymer member 115a is sandwiched between substrates 114a 114b, and a liquid-crystal polymer member 115b is sandwiched between substrates 114c and 114b. The surface of substrates 114a and 114b near liquid-crystal polymer member 115a is provided with electrodes (not shown) that apply an AC voltage to liquid-crystal polymer member 115a, whereas the surface of substrates 114c and 114b near liquid-crystal polymer member 115b is provided with electrodes that apply an AC voltage to liquid-crystal polymer member 115b.

One of the two electrodes that sandwich therebetween liquid-crystal polymer member 115a is a patterned electrode, and the other is a full-area electrode. One of the two electrodes that sandwich therebetween liquid-crystal polymer member 115b is a patterned electrode, and the other is a full-area electrode. Thus, the voltage applied to the liquid-crystal polymer members 115a and 115b can be changed depending on the in-plane position in order to change the image height of the light incident onto the objective lens 106. The arrows shown in FIG. 5 represent the longitudinal direction of the liquid-crystal polymer members 115a and 115b. The liquid-crystal polymer members 115a and 115b have a uniaxial refractive-index anisotropy wherein the direction of optical elastic axis is a longitudinal direction, and “no” is smaller than “ne”, given “no” and “ne” being refractive indexes with respect to a polarized component (ordinary-light component) having a polarization direction perpendicular to the longitudinal direction and a polarized component that is parallel to the longitudinal direction, respectively.

The forward-path light that travels from the semiconductor laser 101 to the disk 107 advances from the bottom toward the top of the drawing, whereas the backward-path light that travels from the disk 107 to the photodetector 110 advances from the top toward the bottom of the drawing. The forward-path light is a linearly-polarized light having a polarization direction parallel to the sheet of drawing, whereas the forward-path light is a linearly-polarized light having a polarization direction perpendicular to the sheet of drawing. It is assumed that the tilt of disk 107 occurs around an axis perpendicular to the sheet of drawing, and it is defined here that the sign of tilt is negative for a counterclockwise tilt, and the sign of tilt is positive for a counterclockwise tilt. The objective lens 106 is designed so that, if the optical axis of the light incident onto the objective lens 106 tilts clockwise with respect to the optical axis of the objective lens 106, there occurs a coma aberration having a polarity opposite to the polarity of the coma aberration attributable to a negative tilt the of disk 107. The objective lens 106 is designed so that, if the optical axis of the light incident onto the objective lens 106 tilts counterclockwise with respect to the optical axis of the objective lens 106, there occurs a coma aberration having a polarity opposite to the polarity of the coma aberration attributable to a positive tilt of the disk 107.

FIG. 5A shows a situation of the control of liquid-crystal optical element 113 for the case where the tilt of disk 107 is zero. RMS value of the AC voltage applied between the electrodes that sandwich therebetween the liquid-crystal polymer members 115a and 115b in this state is constant irrespective of the in-plane position, and is 3.5V for example. The longitudinal direction of the liquid-crystal polymer members 115a and 115b is parallel to the optical axis of the light incident onto the liquid-crystal optical element 113 in the forward path irrespective of the in-plane position. Therefore, the refractive index of the liquid-crystal polymer members 115a and 115b with respect to the forward-path light as well as the refractive index of the liquid-crystal polymer members 115a and 115b with respect to the backward-path light is “no” irrespective of the in-plane position. Thus, the optical axis of the light incident onto the liquid-crystal optical element 113 in the forward path coincides with the optical axis of the light exiting from the liquid-crystal optical element 113. The optical axis of the light incident onto the objective lens 106 coincides with the optical axis of the objective lens 106, and the direction of normal line of the disk 107 coincides with the optical axis direction of the objective lens 106. In this case, the image height of the light incident onto the objective lens 106 is zero, whereby there occurs no coma aberration.

FIG. 5B shows a situation of the control of liquid-crystal optical element 113 for the case where the tilt of disk 107 is negative. The clockwise tilt of the disk 107 tilts the direction of normal line of the disk 107 clockwise with respect to the optical axis direction of the objective lens 106, to generate a coma aberration. Thus, RMS value of the AC voltage applied between the electrodes that sandwich therebetween the liquid-crystal polymer members 115a and 115b is lowered from the left end toward the right end of the drawing. More concretely, 3.5V is applied at the left end, whereas 1.5V is applied at the right end. In this case, at the left end, the longitudinal direction of liquid-crystal polymer member 115a is parallel to the optical axis of the light incident onto the liquid-crystal optical element 113 in the forward path, whereas at the right end, the longitudinal direction is perpendicular to the optical axis of the light incident onto the liquid-crystal optical element 113 in the forward path and parallel to the sheet of drawing. As to the intermediate positions from the left end to the right end, the longitudinal direction is changed from the direction parallel to the optical axis of incident light toward the direction perpendicular to the optical axis and parallel to the sheet of drawing.

The longitudinal direction of liquid-crystal polymer member 115b is also parallel to the optical axis of the light incident onto the liquid-crystal optical element 113 in the forward path at the left end, and is perpendicular to the optical axis of the light incident onto the liquid-crystal optical element 113 in the forward path and perpendicular to the sheet of drawing at the right end. As to the intermediate positions from the left end to the right end, the longitudinal direction changes from the direction parallel to the optical axis of the incident light toward the direction perpendicular to the optical axis and perpendicular to the sheet of drawing. Therefore, the refractive index of liquid-crystal polymer member 115a with respect to the forward-path light and the refractive index of liquid-crystal polymer member 115b with respect to the backward light are “no” at the left end, and “ne” at the right end, changing substantially in accordance with a linear function from the left end toward the right end. Note that the refractive index of liquid-crystal polymer member 115b with respect to the forward-path light and the refractive index of liquid-crystal polymer member 115a with respect to the backward-path light are “no” irrespective of the in-plane position. More specifically, the liquid-crystal optical element 113 functions as a prism with respect to both the forward-path light and the backward-path light. Thus, the optical axis of the light exiting from the liquid-crystal optical element 113 in the forward path tilts clockwise with respect to the optical axis of the light incident onto the liquid-crystal optical element 113. As a result, the optical axis of the light incident onto the objective lens 106 tilts clockwise with respect to the optical axis of the objective lens 106, and the image height of the light incident onto the objective lens 106 is no longer zero, whereby a coma aberration occurs in the objective lens 106. By setting RMS value of the AC voltage applied between the electrodes that sandwich therebetween the liquid-crystal polymer members 115a and 115b at a suitable value, the image height of the light incident onto the objective lens 106 is set at a suitable value, to thereby generate a coma aberration that cancels the coma aberration attributable to the tilt of disk 107 for correcting the coma aberration.

FIG. 5C shows a situation of the control of liquid-crystal optical element 113 for the case where the tilt of disk 107 is positive. The counterclockwise tilt of disk 107 inclines the direction of normal line of the disk 107 counterclockwise with respect to the optical axis direction of the objective lens 106, to generate a coma aberration. Thus, RMS value of the AC voltage applied between the electrodes that sandwich therebetween the liquid-crystal polymer members 115a and 115b is lowered from the right end toward the left end. More concretely, 3.5V is applied at the right end, whereas 1.5V is applied at the left end. In this case, the longitudinal direction of liquid-crystal polymer member 115a is parallel to the optical axis of the light incident onto the liquid-crystal optical element 113 in the forward path at the right end, and is perpendicular to the optical axis of the light incident onto the liquid-crystal optical element 113 in the forward path and parallel to the sheet of drawing at the left end. As to the intermediate positions, the longitudinal direction is changed from the direction parallel to the optical axis of the incident light to the direction perpendicular to the optical axis and parallel to the sheet of drawing, as viewed from the right end to the left end.

The longitudinal direction of liquid-crystal polymer member 115b is parallel to the optical axis of the light incident onto the liquid-crystal optical element 113 in the forward path at the right end, and is perpendicular to the optical axis of the light incident onto the liquid-crystal optical element 113 in the forward path and perpendicular to the sheet of drawing at the left end. As to the intermediate positions from the right end to the left end, the longitudinal direction changes from the direction parallel to the optical axis of the incident light to the direction perpendicular to the optical axis and perpendicular to the sheet of drawing, as viewed from the right end toward the left end. Therefore, the refractive index of liquid-crystal polymer member 115a with respect to the forward-path light and the refractive index of liquid-crystal polymer member 115b with respect to the backward-path light is “no” at the right end and “ne” at the left end, thereby changing substantially in accordance with the linear function from the right end toward the left end. Note that the refractive index of liquid-crystal polymer member 115b with respect to the forward-path light and the refractive index of liquid-crystal polymer member 115a with respect to the backward-path light are “no” irrespective of the in-plane position. More specifically, the liquid-crystal optical element 113 functions as a prism with respect to both the forward-path light and backward-path light. Thus, the optical axis of the light exiting from the liquid-crystal optical element 113 in the forward path tilts counterclockwise with respect to the optical axis of the light incident onto the liquid-crystal optical element 113. As a result, the optical axis of the light incident onto the objective lens 106 tilts counterclockwise with respect to the optical axis of the objective lens 106, and the image height of the light incident onto the objective lens 106 is no longer zero, whereby a coma aberration occurs in the objective lens 106. By setting RMS value of the AC voltage applied between the electrodes that sandwich therebetween the liquid-crystal polymer members 115a and 115b at a suitable value, the image height of the light incident onto the objective lens 106 is set at a suitable value, thereby generating another coma aberration that cancels the coma aberration attributable to the tilt of disk 107 in the objective lens 106 to correct the coma aberration.

In the present embodiment, by controlling the orientation of the liquid-crystal polymer in the liquid-crystal optical element 113 by using an electric signal, the optical axis of the light exiting from the liquid-crystal optical element 113 is changed with respect to the optical axis of the light incident onto the liquid-crystal optical element 113 from the light source, to thereby change the image height of the light incident onto the objective lens 106 for correcting the coma aberration attributable to the tilt of disk 107. In the present embodiment as well, it is not needed to tilt the objective lens 106 by using an actuator upon correcting the coma aberration, whereby a nonaxisymmetric temperature distribution is not generated in the objective lens 106. Therefore, even if a plastic material is used as the material for the objective lens 106, an astigmatism is not generated in the objective lens 106. Accordingly, the shape of focused spot is not disturbed and recording/reproducing characteristic is not degraded. Other advantages are similar to those in the first embodiment.

The relationship between the tilt of optical axis of the light incident onto the objective lens 106 and the coma aberration generated in the objective lens 106 is not limited to the above relationship, and may be reversed from the above. More specifically, the objective lens 106 may be designed so that, if the optical axis of the light incident onto the objective lens 106 tilts counterclockwise with respect to the optical axis of the objective lens 106, a coma aberration having a polarity opposite to the polarity of the coma aberration attributable to a negative tilt of disk 107 occurs in the objective lens 106, and so that if the optical axis of the light incident onto the objective lens 106 tilts clockwise with respect to the optical axis of the objective lens 106, a coma aberration having a polarity opposite to the polarity of the coma aberration attributable to a positive tilt of the disk 107 occurs. In this case, it is sufficient upon correcting the coma aberration that, if the tilt of disk 107 is negative, contrary to FIG. 5, RMS value of the AC voltage applied between the electrodes that sandwich therebetween the liquid-crystal polymer members 115a and 115b be lowered from the right end toward the left end, and that if the tilt of disk 107 is positive, RMS value of the AC voltage applied between the electrodes that sandwich therebetween the liquid-crystal polymer members 115a and 115b be lowered from the left end toward the right end.

In the present embodiment, by allowing the liquid-crystal optical element 113 to have a function as the optical device that changes the object-point position of the light incident onto the objective lens 106, in addition to the function as described above, the function that corrects the spherical aberration attributable to the thickness deviation of the protective layer of disk 107 can be provided to the optical head unit 100a. In this case, the function that corrects the coma aberration attributable to the tilt of disk 107, and the function that corrects the spherical aberration attributable to the thickness deviation of the protective layer of disk 107 can be realized in the optical head unit having a simple configuration.

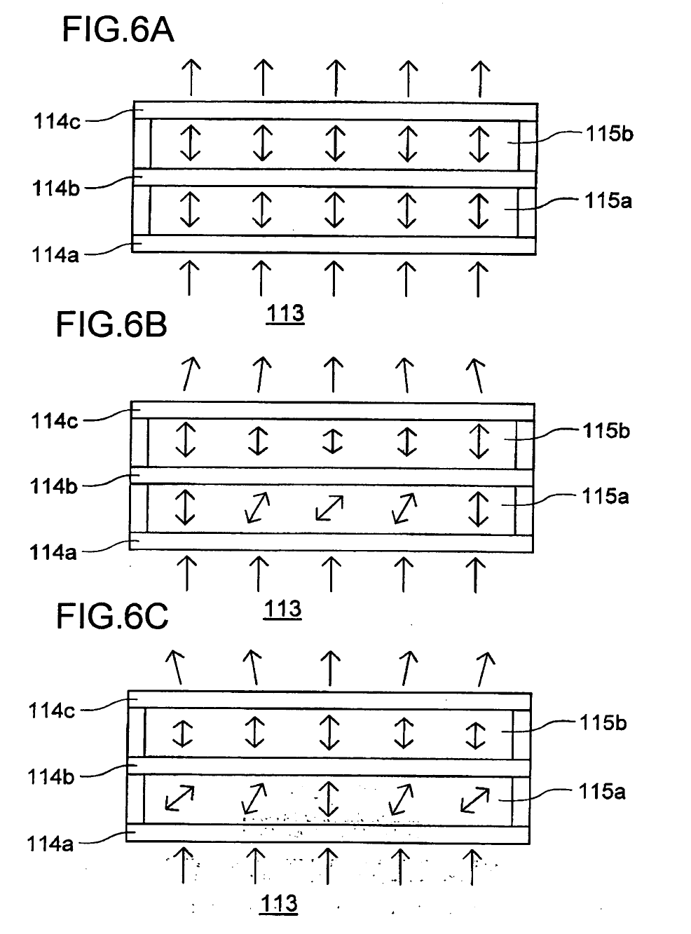

FIGS. 6A to 6C show the situation of controlling the liquid-crystal optical element 113 during changing the object-point position of the light incident onto the objective lens 106. The two electrodes that sandwich therebetween liquid-crystal polymer member 115a are patterned electrodes, and the two electrodes that sandwich therebetween liquid-crystal polymer member 115b are patterned electrodes. In this way, the voltage applied to the liquid-crystal polymer members 115a and 115b can be changed along the in-plane position in order to change the object-point position of the light incident onto the objective lens 106 as well as to change the image height of the light incident onto the objective lens 106. In FIG. 6 as well, the arrows in the figure show the longitudinal direction of the liquid-crystal polymer members 115a and 115b similarly to FIG. 5. The forward-path light that travels from the semiconductor laser 101 to the disk 107 advances from the bottom toward as viewed in the figure, whereas the backward-path light that travels from the from the disk 107 to the photodetector 110 advances from the top toward the bottom in the figure. The forward-path light is linearly-polarized light having a polarization direction parallel to the sheet of drawing, whereas the backward-path light is a linearly-polarized light having a polarization direction perpendicular to the sheet of drawing. The objective lens 106 is designed so that, if the object-point position of the light incident onto the objective lens 106 is infinite, i.e., if the light incident onto the objective lens 106 is parallel light, the spherical aberration generated in the protective layer of disk 107 having the thickness defined by the standard is corrected with respect to the light exiting from the objective lens 106.

FIG. 6A shows the situation of controlling the liquid-crystal optical element 113 for the case where the thickness of protective layer of the disk 107 is equal to the standard value. RMS value of the AC voltage applied between the electrodes that sandwich therebetween the liquid-crystal polymer members 115a and 115b is fixed and may be 3.5V, for example, irrespective of the in-plane position. In this case, the longitudinal direction of the liquid-crystal polymer members 115a and 115b is parallel to the optical axis of the light incident onto the liquid-crystal optical element 113 in the forward path, irrespective of the in-plane position. Therefore, the refractive index of the liquid-crystal polymer members 115a and 115b with respect to the forward-path light as well as the refractive index of liquid-crystal polymer members 115a and 115b with respect to the backward-path light is “no” irrespective of the in-plane position. Thus, the light incident onto the liquid-crystal optical element 113 as a parallel light in the forward path exits as a parallel light from the liquid-crystal optical element 113. Since the light incident onto the objective lens 106 is a parallel light and the object-point position of the light incident onto the objective lens 106 is infinite, there occurs no spherical aberration.

FIG. 6B shows the situation of controlling the liquid-crystal optical element 113 for the case where the thickness of protective layer of the disk 107 is smaller than the standard value. The smaller thickness of protective layer of the disk 107 compared to the standard value incurs a spherical aberration. Thus, RMS value of the AC voltage applied between the electrodes that sandwich therebetween the liquid-crystal polymer members 115a and 115b is lowered from the peripheral part toward the central part, and is set at 3.5V in the peripheral part and 2.5V in the central part, for example. In this case, the longitudinal direction of liquid-crystal polymer member 115a changes from the peripheral part toward the central part. That is, in the peripheral part, the longitudinal direction is parallel to the optical axis of the light incident onto the liquid-crystal optical element 113 in the forward path, and in the central part, the longitudinal direction is at a specific angle with respect to the optical axis of the incident light within the plane parallel to the sheet of drawing including the optical axis of the light incident onto the liquid-crystal optical element 113 in the forward path.

The longitudinal direction of liquid-crystal polymer member 115b is, in the peripheral part, parallel to the optical axis of the light incident onto the liquid-crystal optical element 113 in the forward path, and in the central part, at a specific angle with respect to the optical axis of incident light within the plane that is perpendicular to the sheet of drawing and including the optical axis of the light incident onto the liquid-crystal optical element 113 in the forward path, changing from the peripheral part toward the central part. Therefore, the refractive index of liquid-crystal polymer member 115a with respect to the forward-path light as well as the refractive index of liquid-crystal polymer member 115b with respect to the backward-path light is “no” in the peripheral part, and is an intermediate value between “no” and “ne” in the central part, changing from the peripheral part toward the central part substantially in accordance with a quadratic function. Note that the refractive index of liquid-crystal polymer member 115b with respect to the forward-path light as well as the refractive index of liquid-crystal polymer member 115a with respect to the backward-path light is “no”, irrespective of the in-plane position. That is, the liquid-crystal optical element 113 functions as a lens with respect to both the forward-path light and backward-path light. Thus, the light incident onto the liquid-crystal optical element 113 as a parallel light in the forward path exits as a convergent light from the liquid-crystal optical element 113. As a result, the light incident onto the objective lens 106 is a convergent light, and the object-point position of the light incident onto the objective lens 106 is a finite negative value, whereby an additional spherical aberration occurs in the objective lens 106. By setting RMS value of the AC voltage applied between the electrodes that sandwich therebetween the liquid-crystal polymer members 115a and 115b at a suitable value, the object-point position of the light incident onto the objective lens 106 is set at a suitable value, whereby a spherical aberration that cancels the spherical aberration attributable to the thickness deviation of the protective layer of disk 107 is additionally generated in the objective lens 106 for correcting the spherical aberration.

FIG. 6C shows the situation of the control for the case where the thickness of protective layer of the disk 107 is larger than the standard value. The larger thickness of protective layer of the disk 107 compared to the standard value incurs a spherical aberration. Thus, RMS value of the AC voltage applied between the electrodes that sandwich therebetween the liquid-crystal polymer members 115a and 115b is lowered from the central part toward the peripheral part, and set at 3.5V in the central part and 2.5V in the central part, for example. In this case, the longitudinal direction of liquid-crystal polymer member 115a is, in the central part, parallel to the optical axis of the light incident onto the liquid-crystal optical element 113 in the forward path, and in the peripheral part, at a specific angle with respect to the optical axis of incident light that is within the plane parallel to the sheet of drawing and including the optical axis of the light incident onto the liquid-crystal optical element 113 in the forward path, changing from the central part toward the peripheral part.

The longitudinal direction of liquid-crystal polymer member 115b is, in the central part, parallel to the optical axis of the light incident onto the liquid-crystal optical element 113 in the forward path, and in the peripheral part, at a specific with respect to the optical axis of incident light that is within the plane perpendicular to the sheet of drawing and including the optical axis of the light incident onto the liquid-crystal optical element 113 in the forward path, changing from the central part toward the peripheral part. Therefore, the refractive index of liquid-crystal polymer member 115a with respect to the forward-path light as well as the refractive index of liquid-crystal polymer member 115b with respect to the backward-path light is “no” in the central part, and an intermediate value between “no” and “ne” in the peripheral part, changing from the central part toward the peripheral part substantially in accordance with a quadratic function. Note that the refractive index of liquid-crystal polymer member 115b with respect to the forward-path light as well as the refractive index of liquid-crystal polymer member 115a with respect to the backward-path light is “no”, irrespective of the in-plane position. That is, the liquid-crystal optical element 113 functions as a lens to both the forward-path light and backward-path light. Thus, the light incident onto the liquid-crystal optical element 113 as a parallel light in the forward path exits as a divergent light from the liquid-crystal optical element 113. As a result, the light incident onto the objective lens 106 is a divergent light, and the object-point position of the light incident onto the objective lens 106 is a finite positive value, whereby an additional spherical aberration occurs in the objective lens 106. By setting RMS value of the AC voltage applied between the electrodes that sandwich therebetween the liquid-crystal polymer members 115a and 115b at a suitable value, the object-point position of the light incident onto the objective lens 106 is set at a suitable value, whereby a spherical aberration that cancels the spherical aberration attributable to the thickness deviation of the protective layer of disk 107 is additionally generated in the objective lens 106 for correcting the spherical aberration.

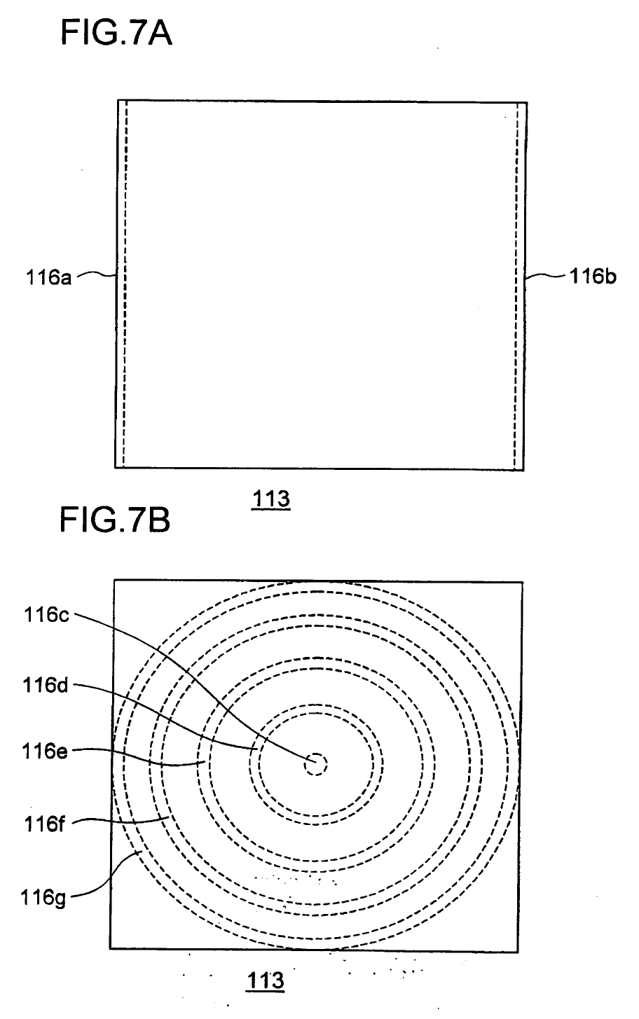

FIGS. 7A and 7B show the liquid-crystal optical element 113 that changes the image height of the light incident onto the objective lens 106 and the object-point position in a top plan view. One of the two electrodes that sandwich therebetween liquid-crystal polymer member 115a as well as one of the two electrodes that sandwich therebetween liquid-crystal polymer member 115b includes a pattern that changes the image height of the light incident onto the objective lens 106, whereas the other of the two electrodes that sandwich therebetween liquid-crystal polymer member 115a as well as the other of the two electrodes that sandwich therebetween liquid-crystal polymer member 115b includes a pattern that changes the object-point position of the light incident onto the objective lens 106. FIG. 7A shows the electrode pattern for changing the image height of the light incident onto the objective lens 106. Electrodes 116a and 116b of a lower resistance are formed on the left end and right end, respectively, and are connected therebetween by an electrode of a higher resistance. FIG. 7B shows the electrode pattern for changing the object-point position of the light incident onto the objective lens 106. Electrodes 116c, 116d, 116e, 116f, and 116g of a lower resistance are formed in this order from the central part toward the peripheral part, and are connected together by an electrode of a higher resistance.

If only the image height of the light incident onto the objective lens 106 is to be changed, electrodes 116c-116g are maintained equipotential. If the tilt of disk 107 is zero, an AC voltage having a RMS value of 3.5V, for example, is applied between electrodes 116a, 116b and electrodes 116c-116g. In this case, the potential of electrode of the higher resistance located between electrodes 116a and 116b is constant irrespective of the in-plane position. If the tilt of disk 107 is negative, an AC voltage having a RMS value of 3.5V, for example, is applied between electrode 116a and electrodes 116c-116g, and an AC voltage having a RMS value of 1.5V, for example, is applied between electrode 116b and electrodes 116c-116g. In this case, the potential of electrode of the higher resistance located between electrodes 116a and 116b is lowered from the left end toward the right end. If the tilt of disk 107 is positive, an AC voltage having a RMS value of 3.5V, for example, is applied between electrode 116b and electrodes 116c-116g, and an AC voltage having a RMS value of 1.5V, for example, is applied between electrode 116a and electrodes 116c-116g. At this stage, the potential of electrode of the higher resistance located between electrodes 116a and 116b is lowered from the right end toward the left end.

If only the object-point position of the light incident onto the objective lens 106 is to be changed, electrodes 116a and 116b are maintained equipotential. If the thickness of protective layer of the disk 107 is equal to the standard value, an AC voltage having a RMS value of 3.5V, for example, is applied between electrodes 116c-116g and electrodes 116a and 116b. In this case, the potential of the electrode of the higher resistance located in the gap of electrodes 116c to 116g is constant irrespective of the in-plane position. If the thickness of protective layer of the disk 107 is smaller than the standard value, an AC voltage having a RMS value of 3.5V, for example, is applied between electrode 116g and electrodes 116a, 116b, an AC voltage having a RMS value of 3.25V, for example, is applied between electrode 116f and electrodes 116a, 116b, and AC voltage having a RMS value of 3.0V, for example, is applied between electrode 116e and electrodes 116a, 116b, an AC voltage having a RMS value of 2.75V, for example, is applied between electrode 116d and electrodes 116a, 116b, and an AC voltage having a RMS value of 2.5V, for example, is applied between electrode 116c and electrodes 116a, 16b. At this stage, the potential of electrode of the higher resistance located in the gap of electrodes 116c to 116g is lowered from the peripheral part toward the central part.

If the thickness of protective layer of the disk 107 is larger than the standard value, an AC voltage having a RMS value of 3.5V, for example, is applied between electrode 116c and electrodes 116a, 116b, an AC voltage having a RMS value of 3.25V, for example, is applied between electrode 116d and electrodes 116a, 116b, an AC voltage having a RMS value of 3.0V, for example, is applied between electrode 116e and electrodes 116a, 116b, an AC voltage having a RMS value of 2.75, for example, is applied between electrode 116f and electrodes 116a, 116b, and an AC voltage having a RMS value of 2.5V, for example, is applied between electrode 116g and electrodes 116a, 116b. At this stage, the potential of electrode of the higher resistance located in the gap of electrodes 116c-116g is lowered from the central part toward the peripheral part.

If both the image height and object-point position of the light incident onto the objective lens 106 is to be changed, electrodes 116a and 116b are not maintained equipotential, and electrodes 116c-116g are not maintained equipotential. The potential of electrodes 116a and 116b is changed depending on the tilt of disk 107, similarly to the case of changing only the image height of the light incident onto the objective lens 106. In addition, the potential of electrodes 116c-116g is changed depending on the thickness deviation of the protective layer of disk 107, similarly to the case of changing only the object-point position of the light incident onto the objective lens 106. In this way, both the image height and object-point position of the incident light can be changed by the liquid-crystal optical element 113.

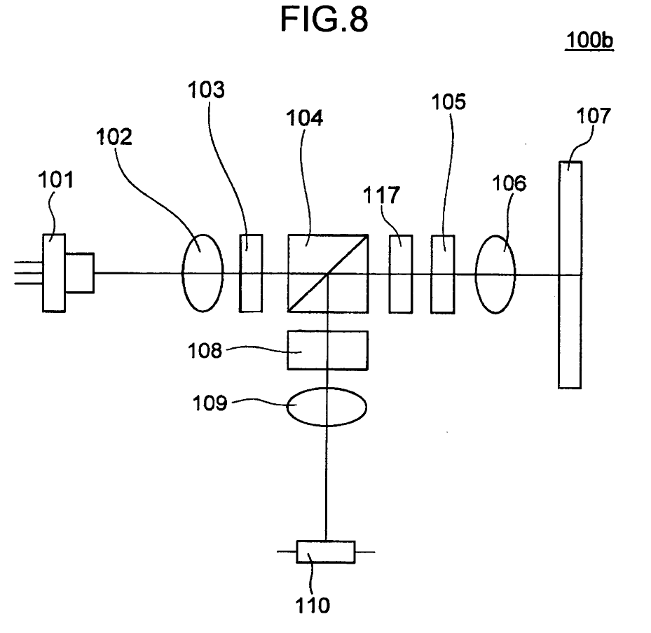

FIG. 8 shows the configuration of an optical head unit according to a third embodiment of the present invention. The optical head unit 100b of the present embodiment uses, instead of the liquid-crystal optical element 113 in FIG. 4, a liquid optical element 117 as the optical device that changes the image height of incident light, and is different in this point from the optical head unit 100a of the second embodiment.

The light exiting from the semiconductor laser 101, which is a light source, is converted by the collimating lens 102 from a divergent light into a parallel light, and divided by the diffractive optical element 103 into three lights including a zero-order light that is the main beam, and ±first-order lights that are subordinate beams. These lights are incident as P-polarized lights onto the polarizing beam splitter 104, pass through the same in an amount of about 100%, pass through the liquid optical element 117, are converted by the ¼-wavelength plate 105 from linearly-polarized lights into circularly-polarized lights, are converted by the objective lens 106 from parallel lights into convergent lights, and are focused within a disk 107 that is the optical recording medium.

The three reflected lights from the disk are converted by the objective lens 106 from divergent lights into parallel lights, are converted by the ¼-wavelength plate 105 from circularly-polarized lights into linearly-polarized light having a polarization direction perpendicular to that in the forward path, pass through the liquid optical element 117 in the backward direction, are incident onto the polarizing beam splitter 104 as S-polarized lights, are reflected therefrom in an amount of about 100%, and are received by the photodetector 110 via the cylindrical lens 108 and convex lens 109. The objective lens 106 does not satisfy the sine condition.

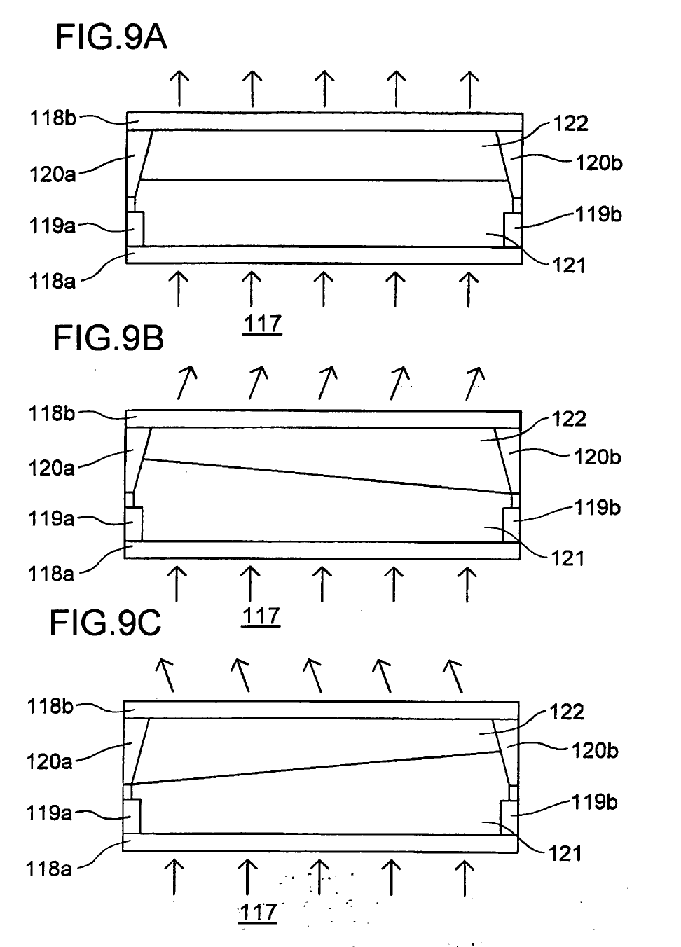

FIGS. 9A to 9C show a section of the liquid optical element 117. The liquid optical element 117 has a configuration wherein water 121 having an electric conductivity and oil 122 having a insulation property are sandwiched between a substrate 118a and another substrate 118b. The peripheral parts of the substrates 118a and 118b are provided with bottom electrodes 119a, 119b and top electrodes 120a, 120b, respectively. The bottom electrodes 119a, 119b formed on the peripheral part of substrate 118a are in contact with the water 121, whereas the top electrodes 120a, 120b formed on the peripheral part of substrate 118b are in contact with the water 121 and oil 122. In the liquid optical element 117, if RMS value of the AC voltage applied between the bottom electrodes and the top electrodes is lower, the area of the portion of the top electrodes in contact with the water 121 is smaller, whereby the thickness of water 121 in the vicinity thereof is smaller. On the other hand, if RMS value of the AC voltage applied between the bottom electrodes and the top electrodes is higher, the area of the portion of the top electrodes in contact with the water 121 is lager, whereby the thickness of water 121 in the vicinity thereof is larger. The refractive index of water 121 is smaller compared to the refractive index of oil 122.

The forward-path light that travels from the semiconductor laser 101 to the disk 107 advances from the bottom toward the top as viewed in the figure, whereas the backward-path light that travels from the disk 107 to the photodetector 110 advances from the top toward the bottom in the figure. It is assumed here that the tilt of disk 107 occurs around an axis perpendicular to the sheet of drawing, and it is defined that a clockwise rotation is negative and a counterclockwise rotation is positive. The objective lens 106 is designed so that, if the optical axis of the light incident onto the objective lens 106 tilts clockwise with respect to the optical axis of the objective lens 106, there occurs a coma aberration having a polarity opposite to the polarity of the coma aberration attributable to a negative tilt of the disk 107, and so that if the optical axis of the light incident onto the objective lens 106 tilts counterclockwise with respect to the optical axis of the objective lens 106, there occurs a coma aberration having a polarity opposite to the polarity of the coma aberration attributable to a positive tilt of the disk 107.

FIG. 9A shows the situation of the control for the case where the tilt of disk 107 is zero. It is assumed that RMS value of the AC voltage applied between bottom electrode 119a and top electrode 120a and RMS value of the AC voltage applied between bottom electrode 119b and top electrode 120b are set at 20V. At this stage, the thickness of water 121 is fixed irrespective of the in-plane position, and the boundary plane between the water 121 and the oil 122 is perpendicular to the optical axis of the light incident onto the liquid optical element 117 in the forward path. Thus, the optical axis of the light incident onto the liquid optical element 117 in the forward path coincides with the optical axis of the light exiting from the liquid optical element 117. The optical axis of the light incident onto the objective lens 106 coincides with the optical axis of the objective lens 106, and the direction of normal line of the disk 107 coincides with the optical axis direction of the objective lens 106. Since the image height of the light incident onto the objective lens 106 is zero in this case, a coma aberration is not generated.

FIG. 9B shows the situation of the control for the case where the tilt of disk 107 is negative. If the disk 107 tilts clockwise, the direction of normal line of the disk 107 tilts clockwise with respect to the optical axis direction of the objective lens 106, whereby there occurs a coma aberration. Thus, RMS value of the AC voltage applied between bottom electrode 119a and top electrode 120a is set at 40V, for example, and RMS value of the AC voltage applied between bottom electrode 119b and top electrode 120b is set at 0V, for example. At this stage, the thickness of water 121 is larger at the left end and smaller at the right end, changing from the left end toward the right end. Therefore, the boundary plane between the water 121 and the oil 122 is a plane of which the normal line tilts clockwise with respect to the optical axis of the light incident onto the liquid optical element 117 in the forward path. That is, the liquid optical element 117 functions as a prism with respect to the incident light. Thus, the optical axis of the light exiting from the liquid optical element 117 in the forward path tilts clockwise with respect to the optical axis of the light incident onto the liquid optical element 117. As a result, the optical axis of the light incident onto the objective lens 106 tilts clockwise with respect to the optical axis of the objective lens 106, and the image height of the light incident onto the objective lens 106 is no longer zero, whereby there occurs a coma aberration in the objective lens 106. By setting RMS value of the AC voltage applied between bottom electrode 119a and top electrode 120a and RMS value of the AC voltage applied between bottom electrode 119b and top electrode 120b at a suitable value, the image height of the light incident onto the objective lens 106 is set at a suitable value, whereby there occurs a coma aberration that cancels the coma aberration attributable to the tilt of disk 107 in the objective lens 106, thereby correcting the coma aberration.

FIG. 9C shows the situation of the control for the case where the tilt of disk 107 is positive. If the disk 107 tilts counterclockwise, the direction of normal line of the disk 107 tilts counterclockwise with respect to the optical axis direction of the objective lens 106, whereby there occurs a coma aberration. Thus, RMS value of the AC voltage applied between bottom electrode 119a and top electrode 120a is set at zero volt, and RMS value of the AC voltage applied between bottom electrode 119b and top electrode 120b is set to 40V. At this stage, the thickness of water 121 is smaller at the left end and larger at the right end, changing from the left end toward the right end. Therefore, the boundary plane between the water 121 and the oil 122 is a plane of which the normal line tilts counterclockwise with respect to the optical axis of the light incident onto the liquid optical element 117 in the forward path. That is, the liquid optical element 117 functions as a prism with respect to the incident light. Thus, the optical axis of the light exiting from the liquid optical element 117 in the forward path tilts counterclockwise with respect to the optical axis of the light incident onto the liquid optical element 117. As a result, the optical axis of the light incident onto the objective lens 106 tilts counterclockwise with respect to the optical axis of the objective lens 106, and the image height of the light incident onto the objective lens 106 is no longer zero, whereby there occurs a coma aberration in the objective lens 106. By setting RMS value of the AC voltage applied between bottom electrode 119a and top electrode 120a and RMS value of the AC voltage applied between bottom electrode 119b and top electrode 120b at a suitable value, the image height of the light incident onto the objective lens 106 is set at a suitable value, whereby there occurs another coma aberration that cancels the coma aberration attributable to the tilt of disk 107 in the objective lens 106 for correcting the coma aberration.

In the present embodiment, change of the shape of the boundary plane of the two liquids in the liquid optical element 117 changes the optical axis of the light exiting from the liquid optical element 117 relative to the optical axis of the light incident onto the liquid optical element 117 from the light source, to change the image height of the light incident onto the objective lens 106, whereby the coma aberration attributable to the tilt of disk 107 is corrected. It is not needed to tilt the objective lens 106 by using the actuator, and a nonaxisymmetric temperature distribution is not generated in the objective lens 106. Thus, even if a plastic material is used as the material for the objective lens 106, an astigmatism does not occur in objective lens 106. Therefore, the shape of focused spot is not disturbed whereby the recording/reproducing characteristic is not degraded. Other advantages are similar to those in the first embodiment.

The relationship between the tilt of optical axis of the light incident onto the objective lens 106 and the coma aberration generated by the objective lens 106 is not limited to the above case, and may be reversed therefrom. More specifically, the objective lens 106 may be designed so that, if the optical axis of the light incident onto the objective lens 106 tilts counterclockwise with respect to the optical axis of the objective lens 106, a coma aberration having a polarity opposite to the polarity of the coma aberration attributable to a negative tilt of the disk 107 is generated, and so that if the optical axis of the light incident onto the objective lens 106 tilts clockwise with respect to the optical axis of the objective lens 106, a coma aberration having a polarity opposite to the polarity of the coma aberration attributable to a positive tilt of the disk 107 is generated. At this stage, upon correcting the coma aberration, if the tilt of disk 107 is negative, in contrast to FIG. 9, RMS value of the AC voltage applied between bottom electrode 119a and top electrode 120a is set at zero volt, for example, and RMS value of the AC voltage applied between bottom electrode 119b and top electrode 120b is set at 40V, for example, whereas if the tilt of disk 107 is positive, RMS value of the AC voltage applied between bottom electrode 119a and top electrode 120a is set at 40V, for example, and RMS value of the AC voltage applied between bottom electrode 119b and top electrode 120b is set at zero volt, for example.

In the present embodiment, by providing the liquid optical element 117 with, in addition to the above function, a function as the optical device that changes the object-point position of the light incident onto the objective lens 106, the optical head unit 100b has the function that corrects the spherical aberration attributable to the thickness deviation of the protective layer of disk 107. In this case, the function that corrects the coma aberration attributable to the tilt of disk 107, and the function that corrects the spherical aberration attributable to the thickness deviation of the protective layer of disk 107 can be realized in the optical head unit having a simple configuration.

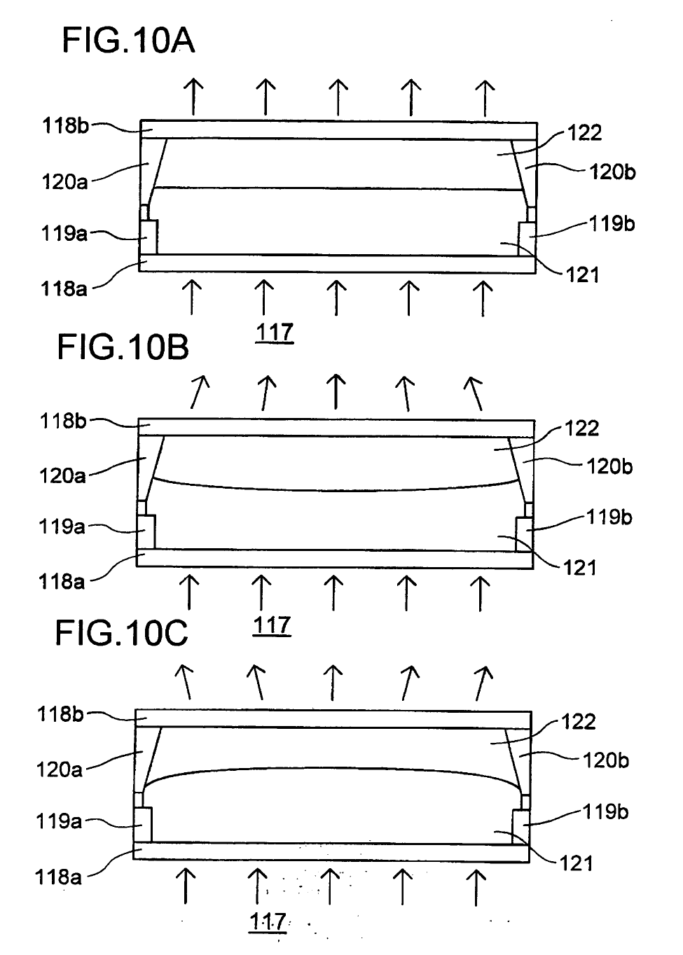

FIGS. 10A to 10C show the situation of controlling the liquid optical element 117 during changing the object-point position of the light incident onto the objective lens 106. The forward-path light that travels from the semiconductor laser 101 to the disk 107 advances from the bottom toward the top as viewed in the figure, whereas the backward-path light that travels from the disk 107 to the photodetector 110 advances from the top toward the bottom in the figure. The objective lens 106 is designed so that, if the object-point position of the light incident onto the objective lens 106 is infinite, that is, if the light incident onto the objective lens 106 is a parallel light, the spherical aberration generated in the protective layer of disk 107 having the thickness defined by the standard is corrected with respect to the light exiting from the objective lens 106.

FIG. 10A shows the situation of controlling the liquid optical element 117 for the case where the thickness of protective layer of the disk 107 is equal to the standard value. RMS value of the AC voltage applied between bottom electrode 119a and top electrode 120a as well as RMS value of the AC voltage applied between bottom electrode 119b and top electrode 120b is 20V, for example. At this stage, the thickness of water 121 is fixed irrespective of the in-plane position, and the boundary plane between the water 121 and the oil 122 is perpendicular to the optical axis of the light incident onto the liquid optical element 117 in the forward path. Thus, the light incident onto the liquid optical element 117 as a parallel light in the forward path exits as a parallel light from the liquid optical element 117. Since the light incident onto the objective lens 106 is a parallel light and the object-point position of the light incident onto the objective lens 106 is infinite, there occurs no spherical aberration.

FIG. 10B shows the situation of controlling the liquid optical element 117 for the case where the thickness of protective layer of the disk 107 is smaller than the standard value. The smaller thickness of protective layer of the disk 107 compared to the standard value incurs a spherical aberration. Thus, RMS value of the AC voltage applied between bottom electrode 119a and top electrode 120a as well as RMS value of the AC voltage applied between bottom electrode 119b and top electrode 120b is set at 30V, for example. At this stage, the thickness of water 121 is larger in the central part and smaller in the peripheral part, changing from the central part to the peripheral part. Therefore, the boundary plane between the water 121 and the oil 122 is a paraboloid that is convex downward and perpendicular to the optical axis of the light incident onto the liquid optical element 117 in the forward path. That is, the liquid optical element 117 functions as a lens with to the incident light. Thus, the light incident onto the liquid optical element 117 as a parallel light in the forward path exits as a convergent light from the liquid optical element 117. As a result, the light incident onto the objective lens 106 is a convergent light, and the object-point position of the light incident onto the objective lens 106 is a finite negative value, whereby an additional spherical aberration occurs in the objective lens 106. By setting RMS value of the AC voltage applied between bottom electrode 119a and top electrode 120a and RMS value of the AC voltage applied between bottom electrode 119b and top electrode 120b at a suitable value, the object-point position of the light incident onto the objective lens 106 is set at a suitable value, to additionally generate a spherical aberration that cancels the spherical aberration attributable to the thickness deviation of the protective layer of disk 107 in the objective lens 106 for correcting the spherical aberration.

FIG. 10C shows the situation of controlling the liquid optical element 117 for the case where the thickness of protective layer of the disk 107 is larger than the standard value. The larger thickness of protective layer of the disk 107 compared to the standard value incurs a spherical aberration. Thus, RMS value of the AC voltage applied between bottom electrode 119a and top electrode 120a as well as RMS value of the AC voltage applied between bottom electrode 119b and top electrode 120b is set at 10V, for example. At this stage, the thickness of water 121 is larger in the central part and smaller in the peripheral part, changing from the central part toward the peripheral part. Therefore, the boundary plane between the water 121 and the oil 122 is a paraboloid that is convex upward and perpendicular to the optical axis of the light incident onto the liquid optical element 117 in the forward path. That is, the liquid optical element 117 functions as a lens with respect to the incident light. Thus, the light incident onto the liquid optical element 117 as a parallel light in the forward path exits as a divergent light from the liquid optical element 117. As a result, the light incident onto the objective lens 106 is a divergent light, and the object-point position of the light incident onto the objective lens 106 is a finite positive value, whereby an additional spherical aberration occurs in the objective lens 106. By setting RMS value of the AC voltage applied between bottom electrode 119a and top electrode 120a as well as RMS value of the AC voltage applied between bottom electrode 119b and top electrode 120b at a suitable value, the object-point position of the light incident onto the objective lens 106 is set at a suitable value, to additionally generate a spherical aberration that cancels the spherical aberration attributable to the thickness deviation of the protective layer of disk 107 in the objective lens 106 for correcting the spherical aberration.

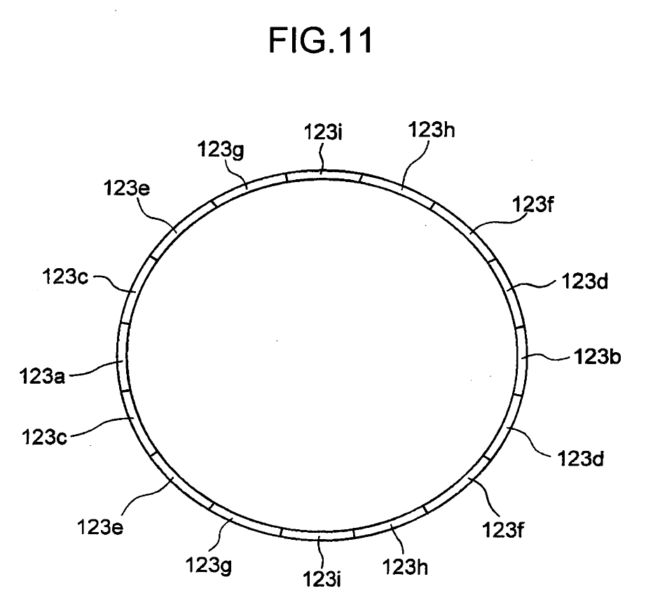

FIG. 11 shows the liquid optical element 117 that changes the image height and object-point position of the light incident onto the objective lens 106, in a top plan view. The periphery of substrates 118a, 118b (FIGS. 10A to 10C) is provided with electrodes 123a-123i, which are divided into 16 areas in the radial direction. In FIG. 11, since arbitrary two electrodes that are located in symmetry with respect to a line passing through the center of substrates 118a, 118b in a horizontal direction in the figure are maintained equipotential, these two electrodes are designate by the same reference symbol. The electrodes 123a-123i each include a bottom electrode formed in the peripheral part of substrate 118a, and a top electrode formed in the peripheral part of substrate 118b. For example, electrode 123a includes a bottom electrode 119a and a top electrode 120a that are shown in FIGS. 9A to 9C and FIGS. 10A to 10C, and electrode 123b includes a bottom electrode 119b and a top electrode 120b that are shown in those drawings.

If only the image height of the light incident onto the objective lens 106 is to be changed, RMS value of the AC voltage applied between the bottom electrode and the top electrode that configure electrode 123i is set at 20V, for example, and the average of RMS values of the AC voltages applied between the bottom electrode and the top electrode configuring arbitrary two electrodes, which are located in symmetry with respect to a vertical line passing through the center of substrates 118a and 118b in the figure, is set at 20V, for example. If the tilt of disk 107 is zero, RMS value of the AC voltage applied between the bottom electrode and the top electrode that configure each of the electrodes 123a-123i is set at 20V. If the tilt of disk 107 is negative, RMS value of the AC voltage applied between the bottom electrode and the top electrode that configure electrode 123a is set at 40V, for example, RMS value of the AC voltage applied between the bottom electrode and the top electrode that configure electrode 123c is set at 38.5V, for example, RMS value of the AC voltage applied between the bottom electrode and the top electrode that configure electrode 123e is set at 34.1V, for example, RMS value of the AC voltage applied between the bottom electrode and the top electrode that configure electrode 123g is set at 27.7V, for example, RMS value of the AC voltage applied between the bottom electrode and the top electrode that configure electrode 123i is set at 20V, RMS value of the AC voltage applied between the bottom electrode and the top electrode that configure electrode 123h is set at 12.3V, RMS value of the AC voltage applied between the bottom electrode and the top electrode that configure electrode 123f is set at 5.9V, for example, RMS value of the AC voltage applied between the bottom electrode and the top electrode that configure electrode 123d is set at 1.5V, for example, and RMS value of the AC voltage applied between the bottom electrode and the top electrode that configure electrode 123b is set at 0V, for example.

If the tilt of disk 107 is positive, the right and left are interchanged therebetween from the case of a negative tilt of the disk, whereby RMS value of the AC voltage applied between the bottom electrode and the top electrode that configure electrode 123a is set at 0V, for example, RMS value of the AC voltage applied between the bottom electrode and the top electrode that configure electrode 123c is set at 1.5V, for example, RMS value of the AC voltage applied between the bottom electrode and the top electrode that configure electrode 123e is set at 5.9V, for example, RMS value of the AC voltage applied between the bottom electrode and the top electrode that configure electrodes 123g is set at 12.3V, for example, RMS value of the AC voltage applied between the bottom electrode and the top electrode that configure electrode 123i is set at 20V, for example, RMS value of the AC voltage applied between the bottom electrode and the top electrode that configure electrode 123h is set at 27.7V, for example, RMS value of the AC voltage applied between the bottom electrode and the top electrode that configure electrode 123f is set at 34.1V, for example, RMS value of the AC voltage applied between the bottom electrode and the top electrode that configure electrode 123d is set at 38.5V, for example, and RMS value of the AC voltage applied between the bottom electrode and the top electrode that configure electrode 123b is set at 40V, for example.

If only the object-point position of the light incident onto the objective lens 106 is to be changed, RMS values of the AC voltages applied between the bottom electrode and the top electrode that configure electrodes 123a-123i are equal to one another. If the thickness of protective layer of the disk 107 is equal to the standard value, RMS valued of the AC voltage applied between the bottom electrode and the top electrode that configure electrodes 123a-123i are set at 20V. If the thickness of the protective layer of disk 107 is smaller than the standard value, RMS value of the AC voltage applied between the bottom electrode and the top electrode that configure electrodes 123a-123i are set at 30V, for example. If the thickness of the protective layer of disk 107 is larger than the standard value, RMS values of the AC voltages applied between the bottom electrode and the top electrode that configure electrodes 123a-123i are set at 10V, for example. If both the object-point position and image height of the light incident onto the objective lens 106 are to be changed, RMS values of the AC voltages applied between the bottom electrode and the top electrode that configure electrodes 123a-123i are set at (V1a+V2a−20V) to (V1i+V2i−20V), respectively, assuming that V1a to V1i are RMS values of the AC voltages applied between the bottom electrode and the top electrode that configure electrodes 123a to 123i, respectively, upon changing only the image height of the light incident onto the objective lens 106, and V2a to V2i are RMS values of the AC voltages applied between the bottom electrode and the top electrode that configure electrodes 123a to 123i, respectively, upon changing only the object-point position of the light incident onto the objective lens 106.

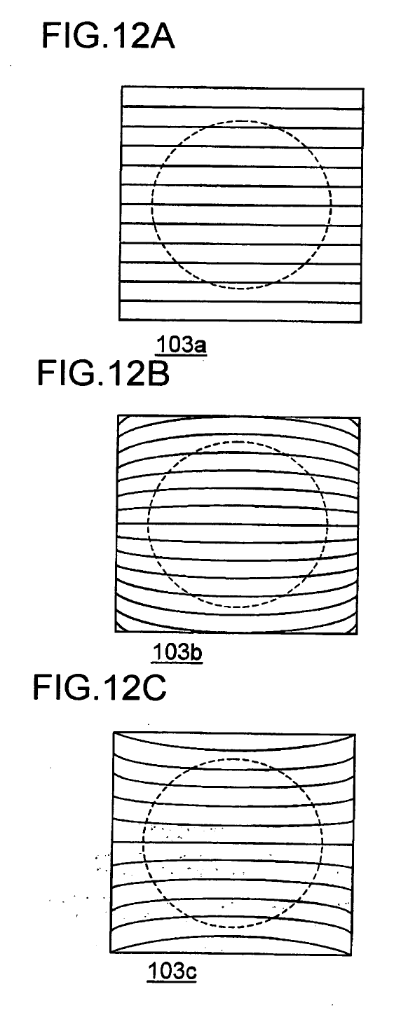

FIGS. 12A to 12C show the diffractive optical element used in the optical head unit of each embodiment in a top plan view. The diffractive optic element 103 has a configuration wherein a diffraction grating is formed on the substrate. An amount of 87.5%, for example, of the light incident onto the diffractive optical element 103 passes as a zero-order light, and an amount of about 5.1%, for example, is diffracted as each of the ±first-order diffracted lights. The zero-order light from the diffractive optical element 103 is referred to as the main beam, whereas the ±first-order diffracted lights are referred to as subordinate beams. At this stage, since the image height of the subordinate beams that are incident onto the objective lens 106 is not zero, there occurs a coma aberration in the objective lens 106 with respect to the subordinate beams incident onto the objective lens 106.

The diffraction grating in the diffractive optical element 103a shown in FIG. 12A has a pattern of a substantially straight line. If this diffractive optical element 103a is used in the optical head unit 100, the shape of focused spot of the subordinate beams is disturbed to degrade the quality of a tracking error signal, because there occurs a coma aberration in the objective lens 106 with respect to the subordinate beams incident onto objective lens 106. On the other hand, the diffraction grating in the diffractive optical element 103b shown in FIG. 12B and the diffractive optical element 103c shown in FIG. 12C have a pattern of a substantially parabola. At this stage, the coma aberration occurs in the diffractive optical elements 103b and 103c with respect to the subordinate beams generated in the diffractive optical elements 103b and 103c. The pattern of the diffraction grating is designed so that the coma aberration generated in the objective lens 106 with respect to the subordinate beams incident onto the objective lens 106 is canceled by a coma aberration generated in the diffractive optical elements 103b and 103c. Therefore, the coma aberration does not occur with respect to the subordinate beams incident onto the objective lens 106 if those diffractive optical elements 103b and 103c are used in the optical head unit 100, whereby the shape of focused spot of the subordinate beams is not disturbed to suppress degradation of the tracing error signal.

The coma aberration generated in the diffractive optical element 103b with respect to the subordinate beams generated in the diffractive optical element 103b has a polarity opposite to the polarity of the coma aberration generated in the diffractive optical element 103c with respect to the subordinate beams generated in the diffractive optical element 103c. Which of the diffractive optical elements 103b and 103c is to be used may be determined by selecting one based on the polarity of the coma aberration generated in the objective lens 106 when the optical axis of the light incident onto the objective lens 106 tilts with respect to the optical axis of the objective lens 106.

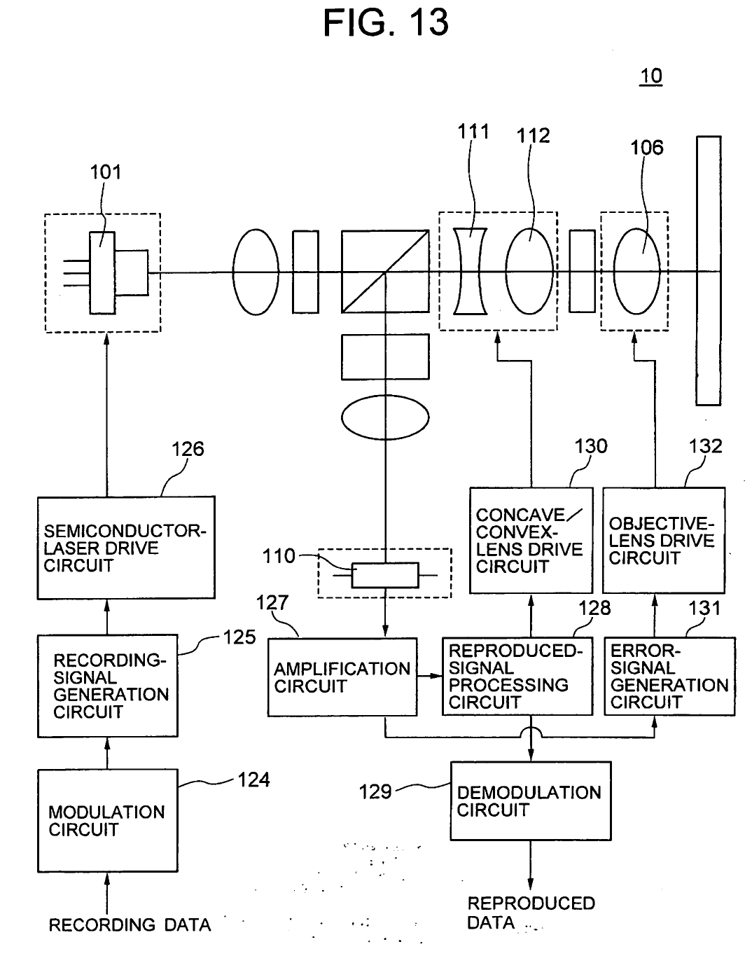

FIG. 13 shows the configuration of an optical information reproducing device including the optical head unit. The optical information recording/reproducing apparatus 10 includes, in addition to the optical head unit 100 shown in FIG. 1, a modulation circuit 124, a recording-signal generation circuit 125, a semiconductor-laser drive circuit 126, an amplification circuit 127, a reproduced-signal processing circuit 128, a demodulation circuit 129, a concave/convex-lens drive circuit 130, an error-signal generation circuit 131, and an objective-lens drive circuit 132.

The modulation circuit 124 modulates the recording data to be recorded on the disk 107 in accordance with a modulation rule. The recording-signal generation circuit 125 generates a recording signal for driving the semiconductor laser 101, in accordance with a recording strategy based on the signal modulated by the modulation circuit 124. The semiconductor-laser drive circuit 126 supplies the current in accordance with the recording signal to the semiconductor laser 101 based on the recording signal generated in the recording-signal generation circuit 125 for driving the semiconductor laser 101. In this way, recording of data onto the disk 107 is performed.

The amplification circuit 127 amplifies the output from the photodetector 110. The reproduced-signal processing circuit 128 performs generation of the reproduced signal including mark/space signals formed along the track on the disk 107 based on the signal amplified in the amplification circuit 127, as well as waveform equalization and binarization. The demodulation circuit 129 demodulates the signal, which is binarized in the reproduced-signal processing circuit 128, in accordance with a demodulation rule. In this way, reproduction of data reproduced from the disk 107 is performed.

The error-signal generation circuit 131 performs generation of a focus error signal and a tracking error signal based on the signal amplified in the amplification circuit 127. The focus error signal is detected by, for example, a known astigmatic technique, and the tracing error signal is detected, for example, by a known phase difference technique or differential push-pull technique. The objective-lens drive circuit 132 supplies a current in accordance with the error signal to the actuator, not illustrated, that drives the objective lens 106 based on the error signal generated in the error-signal generation circuit 131, for driving the objective lens 106. The optical information recording/reproducing apparatus 10 further includes a positioner control circuit and a spindle control circuit that are not illustrated. The positioner control circuit moves the optical head unit 100 as a whole along the radial direction of the disk 107 by using a motor not illustrated. The spindle control circuit rotates the disk 107 by using a motor not illustrated. In this way, operation of the focus servo, tracking servo, positioning servo, and spindle servo is performed.

The concave/convex-lens drive circuit 130 corresponds to the circuit system that drives the optical device so that the coma aberration is corrected. The concave/convex-lens drive circuit 130 supplies current to the actuator not illustrated, which drives the concave lens 111 and convex lens 112, based on the reproduced signal generated in the reproduced-signal processing circuit 128 so that the quality evaluation index of the reproduced signal assumes the best score, to drive at least one of the concave lens 111 and convex lens 112. In this way, operation of correcting the coma aberration and spherical aberration is performed. As the quality evaluation index of the reproduced signal, the amplitude of the reproduced signal, jitter, PRSNR, error rate etc. may be used. In an alternative, the optical information recording/reproducing apparatus may be provided with the function of detecting the coma aberration and spherical aberration, wherein the concave/convex-lens drive circuit 130 drives the concave lens 111 or convex lens 112 so that the coma aberration and spherical aberration assume zero. As the method for detecting the coma aberration and spherical aberration, there is a technique described in JP-2003-51130A, for example.

The optical information recording/reproducing apparatus 10 includes a controller (not shown) that controls the apparatus as a whole. The circuits from the modulation circuit 124 to the semiconductor-laser drive circuit 126 that handle recording of the data, circuits from the amplification circuit 127 to the demodulating circuit 129 that handle reproduction of the data, circuits from the amplification circuit 127 to the objective-lens drive circuit 132 that handle the servo and circuits from the amplification circuit 127 to the concave/convex-lens drive circuit 130 that handle correction of the astigmatism are controlled by the controller.

In the above description, an example is described wherein the optical information recording/reproducing apparatus 10 includes the optical head unit 100 of the first embodiment shown in FIG. 1; however, the optical head unit 100a of the second embodiment shown in FIG. 4 or optical head unit 100b of the third embodiment shown in FIG. 8 may be provided therein instead of the optical head unit 100. If the optical head unit 100a of the second embodiment is used, a liquid-crystal-optical-element drive circuit may be used instead of the concave/convex-lens drive circuit 130 in FIG. 13. In this case, operation of the circuits from the modulation circuit 124 to the semiconductor-laser drive circuit 126 that handle recording of the data, circuits from the amplification circuit 127 to the demodulating circuit 129 that handle reproduction of the data, circuits from the amplification circuit 127 to the objective-lens drive circuit 132 that handle the servo is similar to that as described above. The liquid-crystal-optical-element drive circuit corresponds to the circuit system that drives the optical device so as to correct the coma aberration. The liquid-crystal-optical-element drive circuit supplies a voltage to the electrodes of the liquid-crystal optical element 113 based on the reproduced signal generated in the reproduced-signal processing circuit 128 to drive the liquid-crystal optical element 113 so that the quality evaluation index of the reproduced signal assumes the best score. In this way, operation of correcting the coma aberration and spherical aberration is performed.

If the optical information recording/reproducing apparatus 10 includes the optical head unit 100b of the third embodiment, a liquid-optical-element drive circuit may be provided in FIG. 13, instead of the concave/convex-lens drive circuit 130. Operation of the circuits from the modulation circuit 124 to the semiconductor-laser drive circuit 126 that handle recording of the data, circuits from the amplification circuit 127 to the demodulating circuit 129 that handle reproduction of the data, circuits from the amplification circuit 127 to the objective-lens drive circuit 132 that handle the servo is similar to that as described above. The liquid-optical-element drive circuit corresponds to the circuit system that drives the optical device so as to correct the coma aberration. The liquid-optical-element drive circuit supplies current to the electrodes of the liquid optical element 117 to drive the liquid optical element 117 based on the reproduced signal generated in the reproduced-signal processing circuit 128 so that the quality evaluation index assumes the best score. In this way, operation of correcting the coma aberration and spherical aberration is performed.

In the above description, the optical information recording/reproducing apparatus is a recording/reproducing apparatus that performs recording and reproduction on the disk 107. On the other hand, a reproducing dedicated apparatus that performs only reproduction on the disk 107 or a recording dedicated apparatus that performs only recording may be considered. If the optical information recording/reproducing apparatus is a reproducing dedicated apparatus, the semiconductor laser 101 is not driven based on the recording signal by the semiconductor-laser drive circuit 126, and is driven so that the light quantity of exiting light is constant.

In the optical information recording/reproducing apparatus of the above embodiment, the optical device changes the image height of the light incident onto the objective lens, and if the optical recording medium is tilted, another coma aberration that cancels the coma aberration attributable to the tilt is generated in the objective lens, to thereby correct the coma aberration. Due to the change of the coma aberration generated in the objective lens by changing the image height of the light incident onto the objective lens, it is not needed to tilt the objective lens by using the actuator upon correction of the coma aberration. Thus, the risk of collision of the objective lens with the optical recording medium can be lowered. In addition, since the nonaxisymmetric temperature distribution does not occur in the objective lens, there occurs no astigmatism attributable to the temperature distribution in the objective lens.

Further, a phase distribution generated in the objective lens cancels the phase distribution generated by the coma aberration attributable to the tilt of disk, whereby a higher-order astigmatism is not left with respect to the forward-path light. Even if the objective lens moves within the plane perpendicular to the optical axis, the center of the phase distribution generated by the coma aberration attributable to the tilt of disk is not deviated from the center of the phase distribution generated in the objective lens, whereby there occurs no astigmatism with respect to the forward-path light. Thus, in the present invention, the function that corrects the coma aberration is provided without a disturbance of the shape of focused spot that is attributable to another astigmatism, thereby improving the recording/reproducing characteristic. Further, use of a single-body objective lens as the objective lens facilitates reduction of the size and weight of the objective lens, and facilitates increase of the operating band of the actuator that drives the objective lens and achievement of a higher-speed operation.

As described heretofore, the present invention may have the following configurations.

In the optical head unit of the present invention, a configuration may be employed wherein the image height of the incident light and the coma aberration generated in the objective lens have a specific relationship therebetween, and the optical head unit includes, between the light source and the objective lens, an optical device that changes the image height of light incident onto the objective lens. By changing the image height of the light incident onto the objective lens by using the optical device, to generate a coma aberration that cancels the coma aberration attributable to the tilt when the optical recording medium is tilted, correction of the coma aberration is achieved. Since it is not needed to tilt the objective lens by using the actuator upon correcting the coma aberration, even if a plastic material is used for the objective lens, there occurs no nonaxisymmetric temperature distribution, whereby there occurs no astigmatism in the objective lens. In addition, since the distance between the objective lens and the disk is not reduced upon correcting the coma aberration, the risk that the objective lens collides with the disk is lowered. In addition, since the coma aberration attributable to the tilt of disk is corrected by generating another coma aberration in the objective lens by using the optical device, the phase distribution generated by the coma aberration attributable to the tilt of can be completely cancelled by the phase distribution generated in the objective lens, a higher-order astigmatism does not remain with respect to the forward-path light. In addition, even if the objective lens moves within a plane perpendicular to the optical axis, the center of the phase distribution generated by the coma aberration attributable to the tilt of disk is not deviated from the center of the phase distribution generated in the objective lens, whereby there occurs no astigmatism with respect to the forward-path light. Therefore, use of this optical head unit prevents disturbance of the shape of focused spot and degradation of the recording/reproducing characteristic, even if the optical recording medium tilts. Further, since a single-body objective lens can be used as the objective lens in the present invention, reduction in the size and weight of the objective lens is facilitated, whereby increases in the operating band of the actuator that drives the objective lens is facilitated, thereby facilitating achievement of a higher-speed operation.

In the optical head unit of the present invention, a configuration may be employed wherein the optical device changes the image height of light incident onto the objective lens, and changes an object-point position of light incident onto the objective lens in order to change a spherical aberration generated in the objective lens. In this case, by changing the object-point position of the light incident onto the objective lens by using the optical device, a spherical aberration can be generated in the objective lens, and the spherical aberration attributable to the thickness deviation of protective layer of the optical recording medium from the standard value can be cancelled by this spherical aberration, to thereby correct the spherical aberration attributable to the thickness deviation of the protective layer. In addition, by performing correction of the coma aberration attributable to the tilt of optical recording medium, and correction of the spherical aberration attributable to the thickness deviation of the protective layer of the optical recording medium by using the optical device, the correction of both the aberrations can be achieved in a simple configuration.

In the optical head unit of the present invention, a configuration may be employed wherein the optical device includes a plurality of lenses that are capable of changing a positional relationship among one another. In this case, a configuration may be employed wherein the optical device changes the image height of light incident onto the objective lens by changing a relative location among the plurality of lenses within a plane perpendicular to an optical axis of light incident onto the optical device from the light source. For example, the optical device is configured by a plurality of lenses that can change the positional relationship thereamong. In this case, the image height of the light incident onto the objective lens can be changed by moving the position of either of the two lenses within the plane perpendicular to the optical axis. In this way, a coma aberration is generated in the objective lens for correcting the coma aberration attributable to the tilt of the optical recording medium. In addition, a conventional may be employed wherein either of the two lenses is moved along the optical axis direction to change the distance between the lenses, whereby the object-point position of the light incident onto the objective lens can be changed, to generate another spherical aberration in the objective lens and correct the spherical aberration attributable to the thickness deviation of the protective layer of the optical recording medium.

In the optical head unit of the present invention, a configuration may be employed wherein the optical device comprises a liquid-crystal optical element including a liquid-crystal polymer that changes orientation thereof in accordance with an electric signal. By forming a suitable shape for the electrode that drives the liquid-crystal polymer formed in the liquid-crystal optical element, and driving the electrode on a suitable drive voltage, the light exiting from the liquid-crystal optical element can be tilted with respect to the light incident thereonto, whereby the image height of the light incident onto the objective lens can be changed. By allowing the liquid-crystal optical element also to change the object-point position of the light incident onto the objective lens at this stage, the single liquid-crystal optical element can correct the coma aberration attributable to the tilt of the optical recording medium and the spherical aberration attributable to the thickness deviation of the protective layer of the optical recording medium, whereby the two aberration can be corrected with a simple structure.

In the optical head unit of the present invention, a configuration may be employed wherein the optical device includes a liquid optical element including two liquids that contact each other, and a shape of a boundary plane therebetween is changed in accordance with an electric signal. For example, the optical device is configured by an optical element including two liquids; water and oil. In this case, by changing the position of the boundary plane between the water and the oil, the light exiting from the optical element is changed with respect to the light incident thereonto, to change image height of the light incident onto the objective lens. By employing a configuration wherein the optical element is allowed to change the object-point position of the light incident onto the objective lens at this stage, the single liquid optical element can correct the coma aberration attributable to the tilt of the optical recording medium and the spherical aberration attributable to the thickness deviation of the protective layer of the optical recording medium, whereby the two aberrations can be corrected with a simple structure.

The optical head unit of the present invention may further include between the light source and the objective lens a diffractive optical element that generates a main beam and a plurality of subordinate beams from light exiting from the light source, and have a configuration wherein the plurality of subordinate beams generated by the diffractive optical element have another coma aberration that cancels the coma aberration, which is generated in accordance with an image height in the objective lens with respect to the plurality of subordinate beams. For example, the zero-order light from the diffractive optical element is used as the main beam, whereas the ±first-order lights are used as the subordinate beams. In this case, if the image height of the main beam incident onto the objective lens is zero, the image height of the subordinate beams incident onto the objective lens is not zero, whereby a coma aberration occurs in the objective lens. By generating another coma aberration that cancels this coma aberration in the diffractive optical element, the coma aberration with respect to the subordinate beams can be corrected to thereby suppress the disturbance of shape of the focused spot of the subordinate beams.

In the optical information recording/reproducing apparatus of the present invention, a configuration may be employed wherein the circuit system that drives the optical device so that a coma aberration that the optical device generates by changing the image height of light incident onto the objective lens cancels the coma aberration attributable to a tilt of the optical recording medium.

While the invention has been particularly shown and described with reference to exemplary embodiment thereof, the invention is not limited to these embodiments and modifications. As will be apparent to those of ordinary skill in the art, various changes may be made in the invention without departing from the spirit and scope of the invention as defined in the appended claims.

This application is based upon and claims the benefit of priority from Japanese patent application No. 2007-048608 filed on Feb. 28, 2007, the disclosure of which is incorporated herein in its entirety by reference.

1. An optical head unit comprising:
a light source;
an objective lens that focuses light exiting from said light source to form a focused spot in an optical recording medium; and
a photodetector that receives reflected light from said optical recording medium, wherein:
an image height of light incident onto said objective lens and a coma aberration generated in said objective lens have a specific relationship therebetween;
said optical head unit comprises, between said light source and said objective lens, an optical device that changes said image height of light incident onto said objective lens, in order to change the coma aberration generated in said objective lens.

2. The optical head unit according to claim 1, wherein said optical device changes said image height of light incident onto said objective lens, and changes an object-point position of light incident onto said objective lens in order to change a spherical aberration generated in said objective lens.

3. The optical head unit according to claim 1, wherein said optical device includes a plurality of lenses that are capable of changing a positional relationship among one another.

4. The optical head unit according to claim 3, wherein said optical device changes said image height of light incident onto said objective lens by changing a relative location among said plurality of lenses within a plane perpendicular to an optical axis of light incident onto said optical device from said light source.

5. The optical head unit according to claim 1, wherein said optical device comprises a liquid-crystal optical element including a liquid-crystal polymer that changes orientation thereof in accordance with an electric signal.

6. The optical head unit according to claim 1, wherein said optical device comprises a liquid optical element including two liquids that contact each other, and a shape of a boundary plane therebetween is changed in accordance with an electric signal.

7. The optical head unit according to claim 1, further comprising between said light source and said objective lens a diffractive optical element that generates a main beam and a plurality of subordinate beams from light exiting from said light source, wherein said plurality of subordinate beams generated by said diffractive optical element have another coma aberration that cancels said coma aberration, which is generated in accordance with an image height in said objective lens with respect to said plurality of subordinate beams.

8. An optical information recording/reproducing apparatus comprising: the optical head unit according to claim 1; and a circuit system that drives said optical device so as to correct said coma aberration with respect to light exiting from said objective lens.

9. The optical information recording/reproducing apparatus according to claim 8, wherein said circuit system that drives said optical device drives said optical device so that a coma aberration that said optical device generates by changing the image height of light incident onto said objective lens cancels the coma aberration attributable to a tilt of the optical recording medium.

10. An optical information recording/reproducing apparatus comprising: the optical head unit according to claim 2; and
a circuit system that drives said optical device so as to correct said coma aberration with respect to light exiting from said objective lens.

11. An optical information recording/reproducing apparatus comprising: the optical head unit according to claim 3; and
a circuit system that drives said optical device so as to correct said coma aberration with respect to light exiting from said objective lens.

12. An optical information recording/reproducing apparatus comprising: the optical head unit according to claim 4; and
a circuit system that drives said optical device so as to correct said coma aberration with respect to light exiting from said objective lens.

13. An optical information recording/reproducing apparatus comprising: the optical head unit according to claim 5; and
a circuit system that drives said optical device so as to correct said coma aberration with respect to light exiting from said objective lens.

14. An optical information recording/reproducing apparatus comprising: the optical head unit according to claim 6; and
a circuit system that drives said optical device so as to correct said coma aberration with respect to light exiting from said objective lens.

15. An optical information recording/reproducing apparatus comprising: the optical head unit according to claim 7; and
a circuit system that drives said optical device so as to correct said coma aberration with respect to light exiting from said objective lens.
